(19) United States
(12) Patent Application Publication
(10) Pub. No.: US 2023/0323124 A1
(43) Pub. Date: Oct. 12, 2023

(54) Compositions and Foam Compositions Including Silicone Components, Foam Gaskets, Articles, and Methods

(71) Applicant: 3M INNOVATIVE PROPERTIES COMPANY, St. Paul, MN (US)

(72) Inventors: Junkang Jacob Liu, Woodbury, MN (US); Joshua M. Fishman, St. Louis Park, MN (US); Lianzhou Chen, Woodbury, MN (US); Xiao Gao, Woodbury, MN (US)

(21) Appl. No.: 18/023,014

(22) PCT Filed: Sep. 1, 2021
(86) PCT No.: PCT/IB2021/057984

§ 371 Date: Feb. 24, 2023

Related U.S. Application Data
(60) Provisional application No. 63/085,191, filed on Sep. 30, 2020.

(51) Int. Cl. C08L 83/06; C08J 9/10; C08K 3/36; C08J 9/00; C08J 3/28

(52) U.S. Cl. CPC C08L 83/06; C08J 9/102; C08K 3/36; C08J 9/0066; C08J 9/0061; C08J 3/28; C08J 2383/06; C08J 2333/14

(57) ABSTRACT

Compositions are provided including a chemical blowing agent, a silicone component including an average of more than one free-radically reactive group, and a free-radical initiator. Foam compositions are also provided including a foamed silicone thermoset polymer matrix, fragments of a free-radical initiator, and fragments of a chemical blowing agent. The present disclosure further provides a method of making a foam gasket including dispensing a flowable composition onto a surface of an article and solidifying the flowable composition to form the foam gasket on the surface of the article. The composition includes a chemical blowing agent and a crosslinkable silicone component, and is dispensed at a temperature sufficient to activate the chemical blowing agent. Also, a foam gasket is provided including a foamed silicone thermoplastic polymer matrix and fragments of a chemical blowing agent. An article is additionally provided, including first and second surfaces configured to mate with each other such that when they are mated, the article has a closed clamshell structure. The article further includes a foam gasket disposed on the first surface including a foamed silicone thermoplastic polymer matrix.

### FIELD

The present disclosure relates to compositions, foam compositions, and foam gaskets including silicone components, articles, and methods of forming the foam compositions and foam gaskets.

### BACKGROUND

Foams are porous materials that are composed of gas filled networks or chambers segmented by a solid matrix. The properties of foamed materials are governed by the composition of the matrix material and the morphology of its cellular structure. Silicone foam compositions are widely used as gasketing sealing materials, yet challenges remain in efficiently forming silicone foam gaskets.

### SUMMARY

Compositions, foam compositions, foam gaskets, and articles, plus methods of making foam compositions and foam gaskets are provided.

In a first aspect, a composition is provided. The composition includes a) a chemical blowing agent; b) a silicone component including an average of more than one free-radically reactive group; and c) a free-radical initiator.

In a second aspect, a foam composition is provided. The foam composition includes a foamed silicone thermoset polymer matrix; fragments of a free-radical initiator; and fragments of a chemical blowing agent.

In a third aspect, a method of making a foam gasket is provided. The method includes a) dispensing a flowable composition onto a surface of an article; and b) solidifying the flowable composition to form the foam gasket on the surface of the article. The composition includes 1) a chemical blowing agent; and 2) at least one crosslinkable silicone component. The flowable composition is dispensed at a temperature sufficient to activate the chemical blowing agent.

In a fourth aspect, a foam gasket is provided. The foam gasket includes a foamed silicone thermoplastic polymer matrix and fragments of a chemical blowing agent.

In a fifth aspect, an article is provided. The article includes a) a first surface; b) a second surface configured to mate with the first surface, such that when the first surface and the second surface are mated, the article has a closed clamshell structure; and c) a foam gasket disposed on the first surface. The foam gasket includes a foamed silicone thermoplastic polymer matrix.

Accordingly, compositions, foam compositions, and methods of making foam gaskets are provided with respect to silicone thermoset polymers. Additionally, foam gaskets, articles, and methods of making foam gaskets are provided with respect to silicone thermoplastic polymers. Advantageously, the silicone thermoset polymers and silicone thermoplastic polymers achieve a state of having a low compression set at room temperature faster than achieved by silicone foams cured by alternate curing methods (e.g., using a platinum cure of alkenyl silicones with silicone hydrides or using an acid catalyzed cure of epoxy silicones).

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a flow chart of an exemplary method of making a foam gasket.

FIG. 2 is a photograph of a composition being dispensed onto an article to make a foam gasket, preparable according to the present disclosure.

FIG. 3A is a schematic cross-sectional view of a portion of an article having a surface onto which a composition is being deposited to make a foam gasket, preparable according to the present disclosure.

FIG. 3B is a schematic cross-sectional view of the portion of the article of FIG. 3A in which the foam gasket is forming by foaming of the composition.

FIG. 3C is a schematic cross-sectional view of the portion of the article of FIG. 3B following mating of the surface with a portion of a second surface.

FIG. 3D is a schematic cross-sectional view of the article of FIG. 3C showing recovery of the foam gasket upon separation of the mated surfaces.

FIG. 4A is a schematic top view of a foam gasket disposed on a surface of an article, preparable according to the present disclosure.

FIG. 4B is a schematic cross-sectional side view of the article of FIG. 4A, taken along line 4b-4b.

FIG. 4C is a schematic top view of a foam gasket disposed on a surface of another article, preparable according to the present disclosure.

FIG. 4D is a schematic cross-sectional side view of the article of FIG. 4C, taken along line 4d-4d.

FIG. 5 is a schematic diagram of an assembly line process for preparing an article including a foam gasket.

FIG. 6 is a photograph of a silicone thermoplastic polymer composition forming a foam composition upon being dispensed and deposited onto a surface of an aluminum tray, preparable according to the present disclosure.

FIG. 7A is a Scanning Electron Microscopy (SEM) image of the foam composition of Comparative Example 1 foamed at 380° C.

FIG. 7B is an SEM image of the foam composition of Example 2 foamed at 410° C.

FIG. 7C is an SEM image of the foam composition of Example 3 foamed at 410° C.

FIG. 7D is an SEM image of the foam composition of Example 5 foamed at 410° C.

FIG. 7E is an SEM image of the foam composition of Example 6 foamed at 380° C.

FIG. 7F is an SEM image of the foam composition of Example 7 foamed at 380° C.

FIG. 8A is an SEM image of the foam composition of Example 9 foamed at 121° C.

FIG. 8B is an SEM image of the foam composition of Example 10 foamed at 121° C.

FIG. 8C is an SEM image of the foam composition of Example 13a foamed at 121° C.

FIG. 8D is an SEM image of the foam composition of Example 11 foamed using a heat gun and ultraviolet light radiation.

FIG. 8E is an SEM image of the foam composition of Example 12 foamed using a heat gun and ultraviolet light radiation.

FIG. 8F is an SEM image of the foam composition of Example 13b foamed using a heat gun and ultraviolet (UV) light radiation.

### DETAILED DESCRIPTION

Foams are porous materials that are composed of gas filled networks or chambers segmented by a solid matrix. The properties of foamed materials are governed by the composition of the matrix material and the morphology of its cellular structure. Control over the morphology of a foam's cell structure is often governed by the foaming method to which the matrix material is subjected. Historically, foaming has been achieved using either physical blowing agents (PBAs), which take advantage of the change in volume that occurs during first order phase transitions such as evaporation and sublimation or when a gas experiences a decrease in pressure; chemical blowing agents (CBAs), which are molecules that decompose to gaseous species when heated; or expandable microsphere (EMS), sold by Nouryon and Chase Corporation. EMSs are composed of gas or liquid hydrocarbon PBAs inside a polymer shell. When heated past the glass transition temperature (T_{g}) of the shell, the shell becomes malleable and expands due to the internal pressure of the heated PBA inside. This process leads to a syntactic foam filled with polymer shells that are expanded but not ruptured.

Silicone foams are widely used as gasketing sealing materials (e.g. foam gaskets), where desired characteristics of the foam gasket include one or more of the following: 1) consistent mechanical properties in wide temperature range from −50 to +200° C.; 2) strong resistance to weathering and UV radiation; 3) low moisture absorption; 4) resistance to many chemicals; 5) self-flame retardancy due to low carbon contents and silica char formation, and 6) water repellency.

Many silicone-based foams comprise a silicone thermoset polymer prepared from thermal curing of polymerizable components. Thermal curing, however, tends to have long cure times, while maintaining long enough formulation life time at room temperature, for instance possibly taking more than 10 minutes for a partial cure and at least one hour for a sufficient cure to use a silicone thermoset foam as a foam gasket. If an article including a gasket deposited on one surface is closed prior to complete cure, the further curing of the gasket in contact with a second surface tends to provide a permanent shape to the foam gasket between the two surfaces, which undesirably reduces the shape recovery (or increases the compression set) of the gasket when the article is reopened. Additionally, further cure risks adhering the foam gasket to both surfaces of the article, instead of just one (or neither) surface, affecting re-workability or re-openability of the sealed gasket, when either the article is permanently sealed shut or the foam gasket is at least partially destroyed when the article is open and portions of the foam gasket (or gasket residue) remain attached to each of the surfaces with which the foam gasket had been in contact during curing.

It has been discovered that it is possible to set foam compositions and foam gaskets from silicone components more quickly, where crosslinking more quickly completes than when using thermal curing. More particularly, it has been unexpectedly discovered that a silicone foam can be prepared in under five minutes from a flowable composition dispensed at an elevated temperature onto a surface of an article, in which the flowable composition comprises a chemical blowing agent and at least one crosslinkable silicone component. In certain aspects of the present disclosure, the crosslinkable silicone component comprises a silicone oligomer or polymer. In certain aspects, the crosslinkable silicone component comprises a silicone thermoplastic polymer. Various suitable crosslinkable silicone components and their use in at least one of compositions, foam compositions, foam gaskets, and articles will be described herein.

### GLOSSARY

As used herein, a “monomer” is a single, one unit molecule capable of combination with itself or other monomers to form oligomers or polymers; an “oligomer” is a component having 2 to 9 repeat units; and a “polymer” is a component having 10 or more repeat units.

As used herein, a “silicone component” is an oligomer or polymer having at least one siloxane group.

As used herein, “aliphatic group” means a saturated or unsaturated linear, branched, or cyclic hydrocarbon group. This term is used to encompass alkyl, alkenyl, and alkynyl groups, for example.

As used herein, “alkyl” means a linear or branched, cyclic or acyclic, saturated monovalent hydrocarbon having from one to thirty-two carbon atoms, e.g., methyl, ethyl, 1-propyl, 2-propyl, pentyl, and the like.

As used herein, “alkylene” means a linear saturated divalent hydrocarbon having from one to twelve carbon atoms or a branched saturated divalent hydrocarbon radical having from three to twelve carbon atoms, e.g., methylene, ethylene, propylene, 2-methylpropylene, pentylene, hexylene, and the like.

As used herein, “alkenyl” refers to a monovalent linear or branched unsaturated aliphatic group with one or more carbon-carbon double bonds, e.g., vinyl. Unless otherwise indicated, the alkenyl groups typically contain from one to twenty carbon atoms.

As used herein, “alkenediyl” refers to a straight-chained, branched, or cyclic divalent unsaturated aliphatic group, e.g., —CH═CH—, —CH═C(CH₃)CH₂—, —CH═CHCH₂—, and the like. Unless otherwise indicated, the alkenediyl groups typically contain from one to twenty carbon atoms.

As used herein, “amidine” refers to the functional group R¹C(NR²)NR³, wherein the R groups are independently selected from H, C1-C8 alkyl groups, hydroxyl terminated alkyl groups, and carboxyl terminated alkyl groups.

As used herein, “heteroalkyl” refers to an alkyl group substituted with a heteroatom. The heteroatoms may be pendent atoms, such as fluorine, chlorine, bromine, or iodine, or catenary atoms such as nitrogen, oxygen, boron, or sulfur.

As used herein, “heterocyclic” refers to a cyclic group substituted with a heteroatom. The heteroatoms are caternary atoms such as nitrogen, oxygen, boron, or sulfur.

As used herein, the term “ethylenically unsaturated” refers to a double bond between two carbon atoms, and includes functional groups such as vinyl (H₂C═CH—), including vinyl ethers (H₂C═CHO), vinyl esters (H₂C═CHOCO), styrene (e.g., vinylbenzene) and alkenyl (H₂C═CH(CH₂)ₙ— wherein n typically ranges from 1 to 30 or 1 to 20 or 1 to 10. Ethylenically unsaturated groups also include (meth)acryl such as (meth)acrylamide (H₂C═CHCONH— and H₂C═CH(CH₃)CONH—) and (meth)acrylate(CH₂═CHCOO— and CH₂═C(CH₃)COO—).

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl groups, and linked by an aliphatic segment if containing two or more groups. As used herein, “(meth)acrylate-functional compounds” are compounds that include, among other things, a (meth)acrylate moiety.

As used herein, “thermoplastic” refers to a polymer that flows when heated sufficiently above its glass transition point and becomes solid when cooled.

As used herein, “thermoset” refers to a polymer that permanently sets upon curing and does not flow upon subsequent heating Thermoset polymers are typically chemically crosslinked polymers.

As used herein, “set” refers to a crosslinking process, where the polymer chains are connected to form a 3D network through either covalent bonds (chemical crosslinking) or ionic / hydrogen bonding (physical crosslinking).

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

### Compositions

In a first aspect, a composition is provided. The composition comprises a) a chemical blowing agent; b) a silicone component comprising an average of more than one free-radically reactive group; and c) a free-radical initiator.

The components of the composition are described in detail below.

### Chemical Blowing Agent

Chemical blowing agents (CBAs) are molecules that decompose to gaseous species when heated. The chemical blowing agent is a solid particulate blowing agent and is typically selected from an azocompound, a diazocompound, a sulfonyl hydrazide, a sulfonyl semicarbazide, a tetrazole, a nitrosocompound, an acyl sulfonyl hydrazide, a hydrazone, a thiatriazole, an azide, a sulfonyl azide, an oxalate, a thiatrizine dioxide, isotaoic anhydride, or any combination thereof. Examples of suitable chemical blowing agents include for instance and without limitation, 1,1-azodicarboxamide (AZO), p-toluene sulfonyl hydrazide (Hydrazine), p-toluenesulfonyl semicarbazide (PTSC), and 5H-phenyl tetrazole (5PT). AZO is one of the most common CBAs due to its high gas yield upon degradation and low cost. AZO decomposes when heated at or above 190° C. (with optimal temperatures between 190° C. and 230° C.), and gives off 220 mL/g nitrogen and carbon monoxide in the process. Hydrazine is another common CBA, and decomposes when heated at or above 150° C. (with optimal temperatures between 165° C. and 180° C.), and gives off 120 to 130 mL/g of ammonia, hydrogen, and nitrogen in the process. 5H-phenyl tetrazole is also a suitable CBA, and decomposes when heated at or above 215° C. (with optimal temperatures between 240° C. and 250° C.), and gives off 195 to 215 mL/g of nitrogen in the process. An additional suitable CBA is isatoic anhydride, which decomposes when heated at or above 210° C. (with optimal temperatures between 230° C. and 250° C.), and gives off 115 mL/g of carbon dioxide in the process.

Chemical blowing agents that are also thermal free-radical initiators include those commercially available from Chemours Co. (Wilmington, DE) under the VAZO trade designation including VAZO 88 (1,1′-azo-bis(cyclohexanecarbonitrile), VAZO 67 (2,2′-azo-bis(2-methybutyronitrile)) VAZO 64 (2,2′-azo-bis(isobutyronitrile)) and VAZO 52 (2,2′-azo-bis(2,2-dimethyvaleronitrile)). Other azo-based chemical blowing agents that are also thermal free-radical initiators include those commercially available from FUJIFILM Wake Pure Chemical Corporation (Richmond, VA) including V-70 (2,2′-Azobis(4-methoxy-2,4-dimethylvaleronitrile), V-501 (4,4′-Azobis(4-cyanovaleric acid), V-601 (Dimethyl 2,2′-azobis(2-methylpropionate), VA-086 (2,2′-Azobis[2-methyl-N-(2-hydroxyethyl)propionamide]), VAm-110 (2,2′-Azobis (N-butyl-2-methylpropionamide)), VA-044 (2,2′-Azobis[2-(2-imidazolin-2-yl)propane]dihydrochloride), VA-061 (2,2′-Azobis[2-(2-imidazolin-2-yl)propane]), V-50 (2,2′-Azobis(2-methylpropionamidine)dihydrochloride), and VA-057 (2,2′-Azobis[N-(2-carboxyethyl)-2-methylpropionamidine]tetrahydrate). FUJIFILM also provides macro azo blowing agents including VPS-1001 (4,4-Azobis(4-cyanovaleric acid), polymer with alpha, omega-bis(3-aminopropyl)polydimethylsiloxane) and VPE-0201 (4,4′-Azobis(4-cyanopentanoieacid) Polyethyleneglycolpolymer). Azo-based compounds have a half-life of 1 minute and decompose when heated at or above 58° C. and give off one mole of nitrogen per mole of compound used.

Other chemical blowing agents that are also free radical initiators include O-esters of thiohydroxamates and thiazolethiones as described in U.S. Pat. No. 6,894,082 (Brantl et al.).

The chemical blowing agent is typically present in an amount of 0.1 wt. % or greater, based on the total weight of the composition, 0.25 wt. % or greater, 0.5 wt. % or greater, 1 wt. % or greater, 2 wt. % or greater, 3 wt. % or greater, 4 wt. % or greater, 5 wt. % or greater, 6 wt. % or greater, 7 wt. % or greater, 8 wt. % or greater, 9 wt. % or greater, or 10 wt. % or greater; and 20 wt. % or less, 19 wt. % or less, 18 wt. % or less, 17 wt. % or less, 16 wt. % or less, 15 wt. % or less, 14 wt. % or less, 13 wt. % or less, 12 wt. % or less, or 11 wt. % or less, based on the total weight of the composition. Stated another way, in some embodiments the chemical blowing agent is present in an amount of 0.5 wt. % to 20 wt. %, inclusive; 0.5 to 15 wt. %, 0.5 wt. % to 10 wt. %, 1 to 8 wt. %, or 10 wt. % to 17 wt. %, inclusive, of the total composition. In embodiments in which a composition is foamed in an oven, the chemical blowing agent is often present in an amount of 5 wt. % to 15 wt. %, such as 10 wt. %. In embodiments in which a composition is foamed while being dispensed from an extruder, the chemical blowing agent is often present in an amount of 0.1 wt. % to 10 wt. %, such as 5 wt. %.

In some embodiments, the chemical blowing agent comprises an unencapsulated chemical blowing agent, which means that that chemical blowing agent is free of a shell disposed on its exterior. In select embodiments, a suitable unencapsulated chemical blowing agent comprises a synthetic azo-based compound. An advantage of using a synthetic azo-based compound is that it can also add free-radicals to the composition when the chemical blowing agent decomposes to supplement the free-radicals provided by the free-radical initiator.

In some embodiments, the chemical blowing agent comprises a particle encapsulated within a shell. The shell typically comprises an uncrosslinked thermoplastic material. Often, the uncrosslinked thermoplastic material exhibits a complex viscosity of 3,700 Pa·s or greater at a decomposition temperature of the chemical blowing agent particle. Useful uncrosslinked thermoplastic materials for the shell of encapsulated CBAs, additional materials co-encapsulated with the CBAs, methods of preparing encapsulated CBAs, and the like include, for instance, the encapsulated CBAs described in co-owned International Patent Application No. PCT/IB2020/055405 (Fishman et al.), incorporated herein by reference in its entirety. Encapsulation of CBAs in uncrosslinked (e.g., thermoplastic) polymer shells can lead to foam structures, after the CBA core decomposes and the shells rupture to release the formed gas, with decreased cell size and increased cell density and homogeneity as compared to unencapsulated CBAs. Encapsulation of a chemical blowing agent by a polymer shell provides a composite particle, in which the coating layer surrounds the core particle as a shell layer. Stated differently, such composite particles are core-shell particles.

### Silicone Component

The silicone component comprises an oligomer or a polymer. In certain embodiments, the silicone component comprises an oligomer having two to nine repeat units. In certain embodiments, the silicone component comprises a polymer having ten to ninety-nine repeat units. In some embodiments, the silicone component comprises a polymer having 100 repeat units or greater, 500 repeat units or greater, 1,000 repeat units or greater, 2,000 repeat units or greater, 3,000 repeat units or greater, 4,000 repeat units or greater, 5,000 repeat units or greater, 6,000 repeat units or greater, 7,000 repeat units or greater; and 10,000 repeat units or less, 9,000 repeat units or less, or 8,000 repeat units or less.

Often, the free-radically reactive groups of the silicone component comprise ethylenically-unsaturated groups. The average of more than one free-radically reactive group means that the silicone component may have a single free-radically reactive group in one portion (e.g., chain) of the component and two or more free-radically reactive groups in a different portion (e.g., chain) of the same component, so long as the average for the total silicone component is greater than one per polymer (or oligomer) chain. Having an average of more than one free-radically reactive group, when initiated by the free-radical initiator, results in chemically crosslinking of the silicone component. The silicone component comprises an average of free-radically reactive groups of 1.1 or more, 1.3 or more, 1.5 or more, 1.7 or more, 1.9 or more, 2.0 or more, 2.5 or more, 3.0 or more, 3.5 or more, or 4.0 or more; and an average of free-radically reactive groups of 12 or less, 11 or less, 10 or less, 9.0 or less, 8.0 or less, 7.0 or less, 6.0 or less, or 5.0 or less.

In some embodiments, the silicone component comprises a silicone (meth)acrylate. The silicone (meth)acrylate may comprise a multifunctional silicone (meth)acrylate, a monofunctional silicone (meth)acrylate, or combinations thereof. Any number of different silicone components collectively may be included in the composition, including organosilane monomers in addition to at least one silicone oligomer and/or polymer. Useful silicone (meth)acrylates are described, for instance, in U.S. Pat. App. No. 2009/0149573 (Venzmer et al.) and in U.S. Pat. No. 4,348,454 (Eckberg). Examples of silicone (meth)acrylates include, for example, those available as SILCOLEASE UV100 Series, from Bluestar Silicones, East Brunswick, NJ. Examples of useful polyether-free silicone (meth)acrylates include those available under the trade designations TEGO 2500 (acrylic-modified polydimethylsiloxane), TEGO 2600 (acrylic-modified polysiloxane), TEGO 2650 (acrylic-modified polysiloxane), and TEGO 2700 (acrylic-modified polysiloxane), obtainable from Evonik Industries AG, Essen, Germany. Additional suitable silicone (meth)acrylates include EBECRYL 350 silicone diacrylate and EBECRYL 1360 silicone hexaacrylate from Allnex, as well as CN9800 aliphatic silicone acrylate and CN990 siliconized urethane acrylate compound from Sartomer Co.

Another useful polyether-free silicone (meth)acrylate is TEGO RC 902 (meth)acrylate modified polydialkylsiloxane, which is also commercially available from Evonik Industries AG. This polymer is disclosed in EP 1076081 A1 and is believed to be

(F1, F2, F3)—[(CH₃)₂SiO]₅₆Si(CH₃)₂—(F1, F2, F3)

wherein:

F1 is —(CH₂)₃OCH₂C(CH₂CCH₃)(CH₂O(CO)CH═CH₂)₂

F2 is —(CH₂)₃O(CO)CH₂O(CO)CH═CH₂

F3 is —(CH₂)₃O(CO)(CH₂)₂OCH₂C(CH₂CH₃)(CH₂O(CO)CH═CH₂)

with F1 being the major end group and F2, F3 being end groups that are present in minor amounts only. TEGO RC 902 has a ratio of the average number of dimethylsiloxane groups —OSi(CH₃)₂— to the average number of the sum of (meth)acrylate groups of approximately 14.0. This material has two polymerizable groups per molecule.

Examples of polyether-containing silicone (meth)acrylates include those available under the trade designations TEGO 2200 N (silicone polyether acrylate), TEGO 2250 (silicone polyether acrylate), TEGO 2300 (silicone polyether acrylate), and TEGO 2350 (silicone polyether acrylate), obtainable from Evonik Industries AG.

Fluorinated (meth)acrylated silicones can also be used in the present disclosure. Examples of such materials are described in B. Boutevin, “Synthesis of photocrosslinkable fluorinated polydimethylsiloxanes: direct introduction of acrylic pendant groups via hydrosilylation,” Journal of Polymer Science, Part A, Polymer Chemistry (0887-624X), 38(20), p. 3722 (2000).

Further, suitable silicone acrylates include those available from Shin Etsu Chemical Co., Ltd. (Tokyo, Japan) under the trade designations KP-541, KP-578, KP-543, KP-545, KP-550, and KP-545L.

The silicone component (composed of one or more silicone materials) is typically present in the composition in an amount of 15 wt. % or greater, based on the total weight of the composition, 20 wt. % or greater, 25 wt. % or greater, 30 wt. % or greater, 35 wt. % or greater, or 40 wt. % or greater; and 80 wt. % or less, 75 wt. % or less, 70 wt. % or less, 65 wt. % or less, 60 wt. % or less, 55 wt. % or less, or 50 wt. % or less, based on the total weight of the composition.

### Free-Radical Initiator

In some embodiments, the free-radical initiator comprises a thermally-activated initiator. In some embodiments, a thermal initiator is present in a composition in an amount of up to about 15% by weight, based on the total weight of the composition. In some cases, a thermal initiator is present in an amount of 0.1 wt. % or greater, based on the total weight of the composition, 0.25 wt. % or greater, 0.5 wt. % or greater, 1 wt. % or greater, 2 wt. % or greater, 3 wt. % or greater, 4 wt. % or greater, 5 wt. % or greater, 6 wt. % or greater, 7 wt. % or greater, or 8 wt. % or greater; and 15 wt. % or less, 14 wt. % or less, 13 wt. % or less, 12 wt. % or less, 11 wt. % or less, 10 wt. % or less, or 9 wt. % or less, based on the total weight of the composition. In some embodiments, a thermal initiator is present in an amount of 0.5 to 10 wt. %, based on the total weight of the composition. Suitable thermal initiators include for instance and without limitation, peroxides sold under the trade names TRIGONOX, PERKADOX and LAUROX by Nouryon (Chicago, IL) and LUPERSOL, DELANOX-F, ALPEROX-F, LUCIDOL, LUPERCO and LUPEROX by DuPont (Wilmington, DE) such as dibenzoyl peroxide (PERKADOX L, PERKADOX CH), dilauryl peroxide (LAUROX), diisobutrylperoxide (TRIGONOX 187), cumyl peroxyneodecanoate (TRIGONOX 99), di(3-methoxybutyl) peroxydicarbonate (TRIGONOX 181), 1,1,3,3-tetramethylbutyl peroxyneodecanoate (TRIGONOX 423), tert-amyl peroxyneodecanoate (TRIGONOX 123), di-sec-butyl peroxydicarbonate (TRIGONOX SBP), diisopropyl peroxydicarbonate (TRIGONOX IPP), di(4-tert-butylcyclohexyl) peroxydicarbonate (PERKADOX 16), di(2-ethylhexyl) peroxydicarbonate (TRIGONOX EHP), tert-butyl peroxyneodecanoate (TRIGONOX 23), dicetyl peroxydicarbonate (PERKADOX 24), dimyristyl peroxydicarbonate (PERKADOX 26), di(n-propyl) peroxydicarbonate (LUPERSOL 221), t-butyl peroxymaleic acid (LUPERSOL PMA), 1,1,3,3-tetramethylbutyl peroxypivalate (TRIGONOX 425), tert-amyl peroxypivalate (TRIGONOX 125), tert-butyl peroxypivalate (TRIGONOX 25), di(3,5,5-trimethylhexanoyl) peroxide (TRIGONOX 36), didecanoyl peroxide (PERKADOX SE-10), 2,5-dimethyl-2,5-di(2-ethylhexanoylperoxy)hexane (TRIGONOX 141), 1,1,3,3-tetramethylbutyl peroxy-2-ethylhexanoate (TRIGONOX 421), tert-amyl peroxy-2-ethylhexanoate (TRIGONOX 121), tert-butyl peroxy-2-ethylhexanoate (TRIGONOX 21), tert-butyl peroxyisobutyrate (TRIGONOX 41), 1,1-di(tert-butylperoxy)-3,3,5-trimethylcyclohexane (TRIGONOX 29), 1,1-di(tert-amylperoxy)cyclohexane (TRIGONOX 122), 1,1-di(tert-butylperoxy)cyclohexane (TRIGONOX 22), tert-amylperoxy 2-ethylhexyl carbonate (TRIGONOX 131), tert-amyl peroxyacetate (TRIGONOX 133), tert-butyl peroxy-3,5,5-trimethylhexanoate (TRIGONOX 42), 2,2-di(tert-butylperoxy)butane (TRIGONOX D), tert-butylperoxy isopropyl carbonate (TRIGONOX BPIC), tert-butylperoxy 2-ethylhexyl carbonate (TRIGONOX 117), tert-amyl peroxybenzoate (TRIGONOX 127), tert-butyl peroxyacetate (TRIGONOX F), butyl 4,4-di(tert-butylperoxy)valerate (TRIGONOX 17), tert-butyl peroxybenzoate (TRIGONOX C), dicumyl peroxide (PERKADOX BC), di(tert-butylperoxyisopropyl)benzene(s) (TRIGONOX 14), 2,5-dimethyl-2,5-di(tert-butylperoxy)hexane (TRIGONOX 101), di-tert-butyl peroxide (TRIGONOX B), 3,6,9-triethyl-3,6,9-trimethyl-1,4,7-triperoxonane (TRIGONOX 301), hydroperoxides, e.g., methyl ethyl ketone peroxide, tert-butyl hydroperoxide (TRIGONOX A), cumyl hydroperoxide (TRIGONOX K), isopropylcumyl hydroperoxide (TRIGONOX M), 1,1,3,3-tetramethylbutyl hydoperoxide (TRIGONOX TMBH) and tert-amyl hydroperoxide (TRIGONOX TAHP), dicyclohexyl peroxydicarbonate, 3,3,5,7,7-pentamethyl-1,2,4-trioxepane (TRIGONOX 311), 2,4-petanedione peroxide (LUPERSOL 224) and t-butyl perbenzoate. Examples of commercially available thermal initiators include initiators available from Chemours Co. (Wilmington, DE) under the VAZO trade designation including VAZO 67 (2,2′-azo-bis(2-methybutyronitrile)) VAZO 64 (2,2′-azo-bis(isobutyronitrile)) and VAZO 52 (2,2′-azo-bis(2,2-dimethyvaleronitrile)) Other azo-based chemical blowing agents that are also thermal free-radical initiators include those commercially available from FUJIFILM Wake Pure Chemical Corporation (Richmond, VA) including V-70 (2,2′-Azobis(4-methoxy-2,4-dimethylvalerontrile), V-501 (4,4′-Azobis(4-cyanovaleric acid), V-601 (Dimethyl 2,2′-azobis(2-methylpmpionate), VA-086 (2,2′-Azobis[2-methyl-N-(2-hydroxyethyl)propionamide]), VAm-110 (2,2′-Azobis (N-butyl-2-methylpropionamide)), VA-044 (2,2′-Azobis[2-(2-imidazolin-2-yl)propane]dihydrochloride), VA-061 (2,2′-Azobis[2-(2-imidazolin-2-yl)propane]), V-50 (2,2′-Azobis(2-methylpropionamidine)dihydrochloride), and VA-057 (2,2′-Azobis[N-(2-carboxyethyl)-2-methylpropionamidine]tetrahydrate). FUJIFILM also provides macro azo blowing agents including VPS-1001 (4,4-Azobis(4-cyanovaleric acid), polymer with alpha, omega-bis(3-aminopropyl)polydimethylsiloxane) and VPE-0201 (4,4′-Azobis(4-cyanopentanoicacid) Polyethyleneglycolpolyiner). As mentioned above, the VAZO thermal initiators are also chemical blowing agents.

In some embodiments, the free-radical initiator comprises a UV radiation-activated initiator. A UV radiation-activated initiator may be present in a composition in an amount of 0.1 wt. % or greater, based on the total weight of the composition, 0.25 wt. % or greater, 0.5 wt. % or greater, or 1 wt. % or greater; and 5 wt. % or less, 4 wt. % or less, 3 wt. % or less, or 2 wt. % or less, based on the total weight of the composition in an amount of up to about 5% by weight, based on the total weight of the composition. In some cases, a UV radiation-activated initiator is present in an amount of about 0.1-5% by weight, based on the total weight of the composition. Such a free-radical initiator typically comprises photoinitiator groups selected from acyl phosphine oxide, alkyl amine acetophenone, benzil ketal, xanthone, pentadione, thioxanthrequinone, 2,3-butanedione, phenanthrenequinone, ethylanthraquinone, 1,4-chrysenequinone, camphorequinone, pyrene, hydroxy-acetophenone, benzophenone, organic or inorganic peroxide, a persulfate, titanocene complex, azo, or combinations thereof When the initiator groups include a persulfate, tetramethylethylenediamine may also be included as a curing accelerator.

Examples of suitable photoinitiators comprising a one component system where two radicals are generated by cleavage, typically contain a moiety selected form benzoin ether, acetophenone, benzoyl oxime or acyl phosphine. Suitable exemplary photoinitiators are those available under the trade designation OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6 trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl)butanone (OMNIRAD 369), 2-methyl-1-[4-(methylthio)phenyl]-2-morpholinopropan-1-one (OMNIRAD 907), 2-hydroxy-2-methyl-1-phenyl propan-l-one (OMNIRAD 1173), 2,4,6-trimethylbenzoyldiphenylphosphine oxide (OMNIRAD TPO), and 2,4,6-trimethylbenzoylphenyl phosphinate (OMNIRAD TPO-L). Additional suitable photoinitiators include for example and without limitation, Oligo[2-hydroxy-2-methyl-1-[4-(1-methylvinyl)phenyl]propanone] ESACURE ONE (Lamberti S.p.A., Gallarate, Italy), 2-hydroxy-2-methylpropiophenone, benzyl dimethyl ketal, 2-methyl-2-hydroxypropiophenone, benzoin methyl ether, benzoin isopropyl ether, anisoin methyl ether, aromatic sulfonyl chlorides, photoactive oximes, the photoinitiator TEGO A 18 sold by Evonik, and combinations thereof.

### Optional Monomers

In some embodiments, the composition further comprises at least one derivatized silicone oligomer or functional silane. Some useful silicone oligomers or functional silanes include those commercially available from Millipore Sigma, St. Louis, MO, including for instance and without limitation, 1,3-Divinyltetramethyldisiloxane, 1,4-Bis[dimethyl[2-(5-norbornen-2-yl)ethyl]silyl]benzene, 1,3-Dicyclohexyl-1,1,3,3-tetrakis(dimethylsilyloxy)disiloxane, 1,3-Dicyclohexyl-1,1,3,3-tetrakis(dimethylvinylsilyloxy)disiloxane, 1,3-Dicyclohexyl-1,1,3,3-tetrakis[(norbornen-2-yl)ethyldimethylsilyloxy]disiloxane, 3-Methacrylamidopropyltris(trimethylsiloxy)silane, (3-Methacryloxy-2-hydroxypropoxy)propylbis(trimethylsiloxy)methylsilane, 1,1,3,3-Tetramethyl-1,3-bis[2-(5-norbornen-2-yl)ethyl]disiloxane, 2,4,6,8-Tetramethyl-2,4,6,8-tetravinylcyclotetrasiloxane, N-[3-(Trimethoxysilyl)propyl]-N′-(4-vinylbenzyl)ethylenediamine hydrochloride, and 3-[Tris(trimethylsiloxy)silyl]propyl vinyl carbamate.

In some embodiments, the composition further comprises at least one monomer, which does not contain a silicone group, for instance a reactive diluent. A “reactive diluent,” for reference purposes herein, is a component that contains at least one free radically reactive group (e.g., an ethylenically-unsaturated group) that can co-react with the silicone component (e.g., is capable of undergoing radical polymerization).

Suitable free-radically polymerizable monofunctional diluents include phenoxy ethyl(meth)acrylate, phenoxy-2-methylethyl(meth)acrylate, phenoxyethoxyethyl(meth)acrylate, 3-hydroxy-2-hydroxypropyl(meth)acrylate, benzyl(meth)acrylate, phenylthio ethyl acrylate, 2-naphthylthio ethyl acrylate, 1-naphthylthio ethyl acrylate, 2,4,6-tribromophenoxy ethyl acrylate, 2,4-dibromophenoxy ethyl acrylate, 2-bromophenoxy ethyl acrylate, 1-naphthyloxy ethyl acrylate, 2-naphthyloxy ethyl acrylate, phenoxy 2-methylethyl acrylate, phenoxyethoxyethyl acrylate, 3 -phenoxy-2 -hydroxy propyl acrylate, 2,4-dibromo-6-sec-butylphenyl acrylate, 2,4-dibromo-6-isopropylphenyl (meth)acrylate, benzyl (meth)acrylate, phenyl (meth)acrylate, tetrahydrofurfuryl (meth)acrylate, alkoxylated tetrahydrofurfuryl acrylate, ethoxylated nonyl phenol (meth)acrylate, alkoxylated lauryl (meth)acrylate, alkoxylated phenol (meth)acrylate, stearyl (meth)acrylate, tetrahydrofurfuryl (meth)acrylate, lauryl (meth)acrylate, isodecyl (meth)acrylate, isooctyl (meth)acrylate, octadecyl (meth)acrylate, tridecyl (meth)acrylate, ethoxylated (4) nonyl phenol (meth)acrylate, caprolactone (meth)acrylate, cyclic trimethylolpropane formal (meth)acrylate, 3,3,5-trimethylcyclohexyl (meth)acrylate, dicyclopentadienyl (meth)acrylate, isobutyl (meth)acrylate, n-butyl (meth)acrylate, t-butyl(meth)acrylate, ethyl hexyl (meth)acrylate, isobomyl (meth)acrylate, methyl(meth)acrylate, C1-C20 alkyl (meth)acrylates, 2,4,6-tribromophenyl (meth)acrylate, and the (meth)acrylate monomers described in U.S. Pat. No. 8,137,807 (Clapper et al.), incorporated herein by reference in its entirety.

Reactive diluent may also include the compounds comprising mercapto groups. The chain extension goes by thiol-ene type reactions.

In some embodiments, at least one additional monomer present is not an acrylate. Some such suitable monomers include for instance and without limitation, (meth)acrylamides, (meth)acrylonitriles, vinyl esters, vinyl ethers, n-vinyl pyrrolidinone, n-vinyl caprolactam, vinyl aromatics, vinyl pyridines, vinyl sulfonic acid, vinyl sulfonamides, vinyl sulfonates, vinyl phosphates, ethylene, propylene, styrenics, malonates, or any combination thereof.

Collectively, one or more optional monomers may be present in the composition in an amount of 1 wt. % or greater, based on the total weight of the composition, 2 wt. % or greater, 3 wt. % or greater, 4 wt. % or greater, 5 wt. % or greater, 6 wt. % or greater, 7 wt. % or greater, 8 wt. % or greater, 9 wt. % or greater, or 10 wt. % or greater; and 30 wt. % or less, 25 wt. % or less, 20 wt. % or less, 15 wt. % or less, 13 wt. % or less, or 11 wt. % or less, based on the total weight of the composition.

### Additives

The composition optionally includes one or more additives. Useful additives include for instance and without limitation, at least one physical blowing agent, expandable microspheres, a filler, a cell nucleating agent, a crosslinking agent comprising at least one multifunctional monomer, oligomer, or polymer that does not contain a silicone group, a surfactant, or any combination thereof.

Physical blowing agents include volatile liquid and gas blowing agents that expand when heated and then tend to escape from the mixture, leaving voids behind, to form the foam composition. Physical blowing agents may also include soluble or dissolvable particles or spheres, which leave voids behind to form the foam composition when extracted with an appropriate solvent. The physical blowing agents may be present in an amount ranging from 0.1 wt. % to 10 wt. %, inclusive, based on the total weight of the composition.

In certain embodiments, the composition further comprises a plurality of expandable microspheres. An “expandable microsphere” refers to a microsphere that includes a polymer shell and a core material in the form of a gas, liquid, or combination thereof, which expands upon heating. Expansion of the core material, in turn, causes the shell to expand, at least at the heating temperature. An expandable microsphere is one where the shell can be initially expanded or further expanded without breaking. Some microspheres may have polymer shells that only allow the core material to expand at or near the heating temperature. Hence, during the formation of the foam composition, at least some of the expandable microspheres will expand and form cells in the foam. Suitable expandable microspheres include for instance and without limitation, those available from Pierce Stevens (Buffalo, N.Y.) under the designations F30D, F80SD, and F100D; and from Akzo-Nobel (Sundsvall, Sweden) under the designations EXPANCEL 551, EXPANCEL 461, EXPANCEL 091, and EXPANCEL 930. Each of these microspheres features an acrylonitrile-containing shell. The expandable microspheres may be present in an amount ranging from 0.1 wt. % to 10 wt. %, inclusive, based on the total weight of the composition.

Suitable fillers include for instance and without limitation, silica, alumina, talc, flame retardants, pigments, particles (solid or hollow), flakes (monolayer or multilayer), fibers (chopped or unchopped), or any combination thereof. For example, silica may be present for reinforcement of a foam, as particles (e.g., microparticles and/or nanoparticles), or fibers. For example, silica nanoparticles such as fumed silica may be used and crosslink with the foam matrix during formation of a foam composition. Additionally, fillers (such as silica) may be used to impart a high viscosity, which may assist in retaining foam bubbles during foaming processes. Surprisingly, it was discovered that fumed silica filler included in some compositions did not prevent the use of UV-activated initiators; rather, UV-activated initiators were successful at initiating crosslinking despite the filled composition appearing opaque. Fillers may be present in the composition in an amount of 5 wt. % or greater, based on the total weight of the composition, 10 wt. % or greater, 15 wt. % or greater, 20 wt. % or greater, 25 wt. % or greater, or 30 wt. % to greater; and 60 wt. % or less, 55 wt. % or less, 50 wt. % or less, 45 wt. % or less, or 40 wt. % or less, based on the total weight of the composition.

A cell nucleating agent generally provides initiating sites at which a blowing agent forms voids in a foam composition. By selection of the cell nucleating agent, void sizes in the foam are better controlled (e.g., made smaller or larger), as compared to without including the nucleating agent. Typically, when used, the one or more cell nucleating agents are present in an amount ranging from 0.1 to 15 weight percent, inclusive, based on the total weight of the composition. Examples of useful cell nucleating agents include, for example, talc, silica, silica particles functionalized with organic groups (e.g., an octyl silane, a polyethylene glycol silane), glass beads, polymer particles (e.g., starch (such as hydroxypropyl starch), polystyrene, polyvinyl pyrollidone (PVP)), mica, alumina, clay, calcium silicate, calcium titanate, calcium carbonate, and titania. Hence, certain materials may potentially act as a cell nucleating agent and a filler.

Suitable crosslinking agents (e.g., crosslinkers) are often monomers, oligomers, or low molecular weight polymers that contain multiple reactive functional groups. Some crosslinking agents used herein do not contain a silicone group. One class of useful crosslinking agents are multifunctional (meth)acrylate species. Multifunctional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates. Other classes of useful crosslinking agents are multifunctional crosslinkers comprising functional groups selected from acrylamides, acrylonitriles, (meth)acrylonitriles, vinyl esters, vinyl ethers, n-vinyl pyrrolidinone, n-vinyl caprolactam, vinyl aromatics, ethylene, styrenics, malonates, or any combination thereof.

Suitable free-radically polymerizable multifunctional crosslinking agents include di-, tri-, or other poly-acrylates and methacrylates such as glycerol diacrylate, ethoxylated bisphenol A dimethacrylate (D-zethacrylate), tetraethylene glycol dimethacrylate (TEGDMA), polyethyleneglycol dimethacrylate (PEGDMA), glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, 1,4 -butanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis [1-(3-acryloxy-2-hydroxy)]-p-propoxyphenyldimethylmethane, and trishydroxyethyl-isocyanurate trimethacrylate; bis-acrylates of polyesters (e.g., methacrylate-terminated polyesters); the bis-acrylates and bis-methacrylates of polyethylene glycols of molecular weight 200-500, copolymerizable mixtures of acrylated monomers such as those in U.S. Pat. No. 4,652,274 (Boettcher et al.), and acrylated oligomers such as those of U.S. Pat. No. 4,642,126 (Zador et al.); polyfunctional (meth)acrylates comprising urea or amide groups, such as those of EP2008636 (Hecht et al). The crosslinking agent can comprise one or more poly(meth)acrylates, for example, di-, tri-, tetra- or pentafunctional monomeric or oligomeric aliphatic, cycloaliphatic or aromatic acrylates or methacrylates.

Examples of suitable aliphatic poly(meth)acrylates having more than two (meth)acrylate groups in their molecules are the triacrylates and trimethacrylates of hexane-2,4,6-triol; glycerol or 1,1,1-trimethylolpropane; ethoxylated or propoxylated glycerol or 1,1,1-trimethylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate.

Another suitable class of free radical polymerizable compounds includes aromatic di(meth)acrylate compounds and trifunctional or higher functionality (meth)acrylate compound.

Trifunctional or higher functionality meth(acrylates) can be tri-, tetra- or pentafunctional monomeric or oligomeric aliphatic, cycloaliphatic or aromatic acrylates or methacrylates.

Examples of suitable aliphatic tri-, tetra- and pentafunctional (meth)acrylates are the triacrylates and trimethacrylates of hexane-2,4,6-triol; glycerol or 1,1,1-trimethylolpropane; ethoxylated or propoxylated glycerol or 1,1,1-tri-methylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate. In some embodiments, tri(meth)acrylates comprise 1,1-trimethylolpropane triacrylate or methacrylate, ethoxylated or propoxylated 1,1,1-trimethylolpropanetriacrylate or methacrylate, ethoxylated or propoxylated glycerol triacrylate, pentaerythritol monohydroxy triacrylate or methacrylate, or tris(2-hydroxy ethyl) isocyanurate triacrylate. Further examples of suitable aromatic tri(meth)acrylates are the reaction products of triglycidyl ethers of trihydroxy benzene and phenol or cresol novolaks containing three hydroxyl groups, with (meth)acrylic acid.

In some cases, a (multifunctional) crosslinking agent comprises diacrylate and/or dimethacrylate esters of aliphatic, cycloaliphatic or aromatic diols, including 1,3- or 1,4-butanediol, neopentyl glycol, 1,6-hexanediol, dodecane diol, diethylene glycol, triethylene glycol, tetraethylene glycol, polyethylene glycol, tripropylene glycol, ethoxylated or propoxylated neopentyl glycol, 1,4-dihydroxymethylcyclohexane, 2,2-bis(4-hydroxycyclohexyl)propane or bis(4-hydroxycyclohexyl)methane, hydroquinone, 4,4′-dihydroxybiphenyl, bisphenol A, bisphenol F, bisphenol S, ethoxylated or propoxylated bisphenol A, ethoxylated or propoxylated bisphenol F or ethoxylated or propoxylated bisphenol S. In some cases, a crosslinking agent described herein comprises one or more higher functional acrylates or methacrylates such as dipentaerythritol monohydroxy pentaacrylate or bis(trimethylolpropane)tetraacrylate.

The crosslinking agent is used in an effective amount, by which is meant an amount that is sufficient to cause crosslinking of the composition to provide adequate cohesive strength to produce a desired foam composition. When used, the crosslinking agent is present in an amount of 0.005 wt. % or greater, 0.01 wt. % or greater, 0.025 wt. % or greater, 0.05 wt. % or greater, 0.1 wt. % or greater, 0.25 wt. % or greater, 0.5 wt. % or greater, 1.0 wt. % or greater, or 2.0 wt. % or greater, based on the total weight of the composition; and 10 wt. % or less, 7.5 wt. % or less, 5.0 wt. % or less, 4.5 wt. % or less, 4.0 wt. % or less, 3.5 wt. % or less, 3.0 wt. % or less, 2.5 wt. % or less, 1.0 wt. % or less, or 0.5 wt. % or less, based on the total weight of the composition.

A surfactant can assist in stabilizing a foam composition. Suitable surfactants can be nonionic, anionic, or cationic, and include for instance and without limitation, nonionic surfactants including sorbitan esters such as sorbitan monooleate and polyoxyethylene sorbitan monostearate; polyoxyethylene alkyl ethers, polyoxyethylene alkyl phenyl ethers, polyoxyethylene alkyl esters, and combinations thereof. Suitable anionic surfactants include salts of alkyl sulfates such as sodium lauryl sulfate and sodium myristyl sulfate; salts of alkylarylsulfonic acid such as sodium dodecylbenzenesulfonate and potassium dodecylbenzenesulfonate; salts of sulfosuccinic acid ester such as sodium dioctyl sulfosuccinate and sodium dihexyl sulfosuccinate; salts of aliphatic acid such as ammonium laurate and potassium stearate; salts of polyoxyethylene alkyl sulfate; salts of polyoxyethylene alkyl aryl sulfate; salts of resin acid, and combinations thereof. Suitable cationic surfactants include cetylpyridinium chloride and cetyltrimethylammonium bromide. If included, one or more surfactants may be present in an amount of 0.005 wt. % to 5 wt. %, based on the total weight of the composition.

In preparing a composition as described herein, the components (e.g., uncrosslinked thermoplastic matrix material, composite particles, and other optional components) are thoroughly mixed using any suitable means known by those of ordinary skill in the art. For example, the composition may be mixed by use of a (e.g., Brabender, SpeedMixer) mixer, extruder, kneader or the like. In some embodiments, the components are also heated (e.g., subjected to a temperature ranging from 90° C.-220° C., inclusive).

### Foam Compositions

In a second aspect, a foam composition is provided. The foam composition comprises a foamed silicone thermoset polymer matrix; fragments of a free-radical initiator; and fragments of a chemical blowing agent. The foam composition is formed by polymerizing and foaming the composition described above with respect to the first aspect. The foamed silicone polymer matrixis a thermoset due to the presence of the silicone component having an average of more than one free-radically reactive groups, plus any optional multifunctional components (e.g., monomers, crosslinking agents, etc.) present in the composition prior to foaming. In many embodiments, the silicone thermoset polymer matrix comprises a silicone (meth)acrylate polymer.

The foaming process decomposes (at least a portion of) each of the chemical blowing agent and the free-radical initiator present in the composition so that the foam composition includes fragments of each of the chemical blowing agent and the free-radical initiator. For instance, many azo initiators having the same general structure decompose to release nitrogen and form the fragments shown in the scheme below:

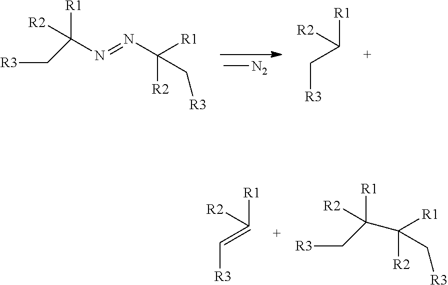

In the above scheme, R1 may be selected from —CN, —COOR, or —CONR4R5, wherein R2 and R3 may be independently selected from H, linear alkyl groups, cyclic alkyl groups, heteroalkyl groups, heterocyclic groups, amidine groups, hydroxyl terminated alkyl groups, or carboxyl terminated alkyl groups; wherein R is H or a C1-C4 alkyl; wherein R4 is a C1-C4 alkylene; and wherein R5 is a C1-C4 alkyl, H, or —OH.

For instance, fragments of OMNIRAD 651 include methylbenzoate, benzaldehyde, benzil, and acetophenone; fragments of OMNIRAD 819 include 2,4,6-trimethylbenzaldehyde and phenyl phosphine oxide species; and fragments of OMNIRAD 369 include 4-morpholine benzaldehyde. Fragments of a chemical blowing agent or free-radical initiator can be detected, for instance, by infrared spectroscopy of the foam composition.

In some embodiments in which the chemical blowing agent was an encapsulated chemical blowing agent, the encapsulation shell is present as a plurality of particulates distributed (e.g., dispersed) in the foam matrix. The particulates are typically remnants of shells of the composite particles after they rupture during the foaming process. In certain embodiments, the shell particulates are present as a blend with the foamed silicone thermoset polymer matrix. There may potentially also be some chemical blowing agent particles remaining in the foam composition that did not decompose during the foaming process, which may be identified by image analysis of a cross-section of the foam composition using scanning electron microscopy (SEM).

Preferably, the foam composition exhibits a compression set of 50% or less, 45% or less, 40% or less, 35% or less, 30% or less, or 20% or less. The compression set may be determined using EN ISO 1856-2000, using Method C, at a temperature of 85° C. and 50% compression deflection for 24 hours. Also, instead of using samples that were 24-26 millimeters thick, compression set of samples in the Examples below were each used at the thickness of the formed sample. This compression set method provides 50% of the compression set value at 50% compression deflection. Low values of (e.g., permanent) compression set assure the resiliency of the foam composition, which is advantageous when the foam composition is a foam gasket used for maintaining an adequate seal during the lifetime of a container and facilitating foam gasket reuse if the container is reopened for rework of protected contents (e.g., a battery).

In some embodiments, the foam composition has a specific gravity of less than 1, less 0,9, less than 0.8, less than 0.7, less than 0.6, or even less than 0.5, as determined by measuring density, for instance using a density kit commercially available from Mettler Toledo, LLC (Columbus, OH) (e.g., Density kit XPR/XSR-Ana) installed on an analytical laboratory balance. The specific gravity is the ratio between the density of the foam composition and the density of water, which is taken to be I gram per cubic centimeter. A low specific gravity can be advantageous for applications in which light-weight materials are desirable, for instance for use in an automobile.

In some embodiments, the foam composition comprises a “closed cell” foam, which means that the foam contains substantially no connected cell pathways that extend from one outer surface through the material to another outer surface. A closed cell foam can include up to about 10% open cells, within the meaning of “substantially” no connected cell pathways. Stated another way, a closed cell foam composition comprises 90% or greater closed cells, 92% or greater closed cells, 95% or greater closed cells, or 98% or greater closed cells. In contrast, a foam composition having interconnected pathways between adjacent cells in the foam structure is called an “open cell” foam. In some embodiments, the foam composition comprises an open cell foam.

Foam cells can be characterized by image analysis of a cross-section using SEM. Various properties of the foam compositions can include, for instance, cell size, cell size distribution, cell density, and cell aspect ratio. In certain embodiments, the foam composition has a unimodal cell size distribution, whereas in other embodiments the foam composition has a multimodal cell size distribution.

In certain embodiments, the foam composition comprises an average cell size of 2 millimeters or less, 1.8 millimeters or less, 1.6 millimeters or less, 1.4 millimeters or less, 1.2 millimeters or less, 1 millimeter or less, 900 micrometers or less, 800 micrometers or less, 700 micrometers or less, 600 micrometers or less, 500 micrometers or less, 400 micrometers or less, or 300 micrometers or less; and 1 micrometer or greater, 2 micrometers or greater, 5 micrometers or greater, 10 micrometers or greater, 15 micrometers or greater, 25 micrometers or greater, 50 micrometers or greater, 75 micrometers or greater, 100 micrometers or greater, 125 micrometers or greater, 150 micrometers or greater, 175 micrometers or greater, 200 micrometers or greater, 225 micrometers or greater, or 250 micrometers or greater. In an embodiment, the foam composition has an average cell size of 250 to 750 micrometers.

Optionally the foam composition has a shape of a gasket.

### Process of Making a Foam Gasket

In a third aspect, a method of making a foam gasket is provided. The method of making a foam gasket comprises:
a) dispensing a flowable composition onto a surface of an article, the composition comprising 1) a chemical blowing agent; and 2) at least one crosslinkable silicone component, wherein the flowable composition is dispensed at a temperature sufficient to activate the chemical blowing agent; and
b) solidifying the flowable composition to form the foam gasket on the surface of the article.

In some embodiments, the article comprises an enclosed article, for instance a battery pack. Battery packs enclose batteries in a water-proof and dust-proof article, and may be used, for instance, in a hybrid or electric vehicle.

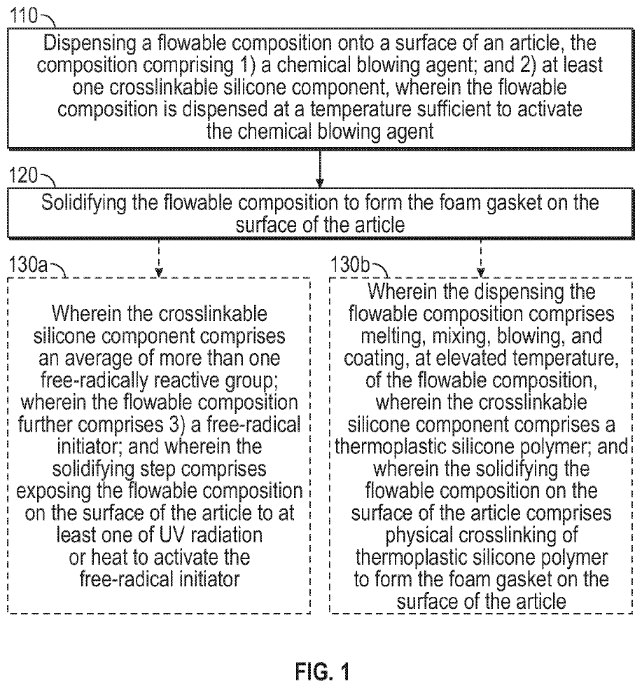

Referring to FIG. 1, a flow chart is provided of the methods of the third aspect. More particularly, the method comprises Step 110 of dispensing a flowable composition onto a surface of an article, the composition comprising 1) a chemical blowing agent; and 2) at least one crosslinkable silicone component, wherein the flowable composition is dispensed at a temperature sufficient to activate the chemical blowing agent. The method further comprises Step 120 of solidifying the flowable composition to form the foam gasket on the surface of the article.

The dispensing temperature will vary based on the decomposition temperature of the chemical blowing agent, and often includes a temperature ranging from 55° C. to 250° C., inclusive. Upon heating the flowable composition, the chemical blowing agent assists in generating voids to form the foam composition. In some embodiments, more than one blowing agent may be used in certain foam compositions, and the blowing agent may comprise any one or more of an unencapsulated chemical blowing agent or an encapsulated chemical blowing agent, plus optionally an unencapsulated physical blowing agent, or expandable microspheres. Useful categories of blowing agents include, for instance, a volatile liquid, a gas, a chemical compound, and a plurality of expandable microspheres. Volatile liquid and gas blowing agents expand when heated and then tend to escape from the flowable composition, leaving voids behind, to form the foam composition. Chemical compound blowing agents decompose and at least a portion of the decomposition product(s) expand and then escape from the mixture, leaving voids behind. In some embodiments, the blowing agent comprises a plurality of expandable microspheres, which are described above.

In preparing a composition as described herein, the components are thoroughly mixed using any suitable means known by those of ordinary skill in the art. For example, the composition may be mixed by use of a (e.g., Brabender) mixer, extruder, kneader or the like.

In some embodiments, the flowable composition exhibits a viscosity at the dispensing temperature of 10,000 centipoises (cP) or greater, 25,000 cP or greater, 50,000 cP or greater, 75,000 cP or greater, 100,000 cP or greater, 150,000 cP or greater, 200,000 cP or greater, 250,000 cP or greater, or 300,000 cP or greater; and 1,000,000 cP or less, 900,000 cP or less, 800,000 cP or less, 700,000 cP or less, 600,000 cP or less, 500,000 cP or less, or 400,000 cP or less. In some embodiments, the flowable composition exhibits a viscosity at the dispensing temperature of 300,000 cP to 500,000 cP. The viscosity is the dynamic viscosity and can be measured using a rheometer having a parallel plate (25 millimeter (mm) diameter) geometry and a 1 mm gap, at 25° C. at a shear rate of 100 s⁻¹.

In certain embodiments, the at least one crosslinkable silicone component comprises a silicone component according to the first aspect described in detail above. In such embodiments, the method further comprises (optional) Step 130a, wherein the crosslinkable silicone component comprises an average of more than one free-radically reactive group; wherein the flowable composition further comprises 3) a free-radical initiator; and wherein the solidifying step comprises exposing the flowable composition on the surface of the article to at least one of UV radiation or heat to activate the free-radical initiator. The chemical blowing agent and the free-radical initiator are each as described in detail above with respect to the first aspect.

In some embodiments, the flowable composition is exposed to UV radiation, for instance to generate free radicals from a UV radiation-activated initiator (e.g., having one or more photoinitiator groups). In some embodiments, the flowable composition is exposed to heat, for instance to generate free radicals from a thermally-activated initiator. Optionally, the flowable composition is exposed to each of UV radiation and heat. In such cases, the exposure may be simultaneous and/or sequential. When the exposure to each of UV radiation and heat is sequential, the order of exposure can be either of UV radiation first or heat first. When the exposure is sequential, there may also be some overlap in exposure to each of UV radiation and heat.

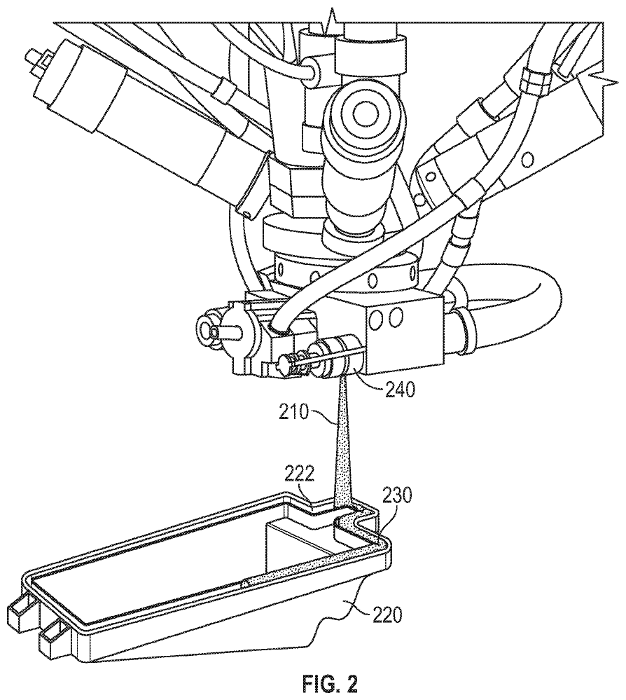

Referring to FIG. 2, a photograph is provided of a foam gasket being formed in place on an article. More particularly, a flowable composition 210 is dispensed onto a surface 222 of an article 220 at a temperature sufficient to activate a chemical blowing agent contained in the flowable composition 210. The method further comprises solidifying the flowable composition 210 that has been dispensed onto a surface 222 of the article 220 to form the foam gasket 230. The flowable composition is dispensed from a nozzle 240. The nozzle is optionally part of a hot melt dispenser.

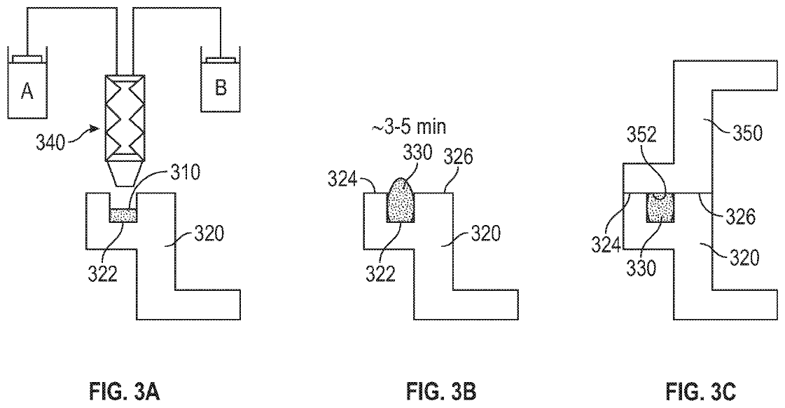

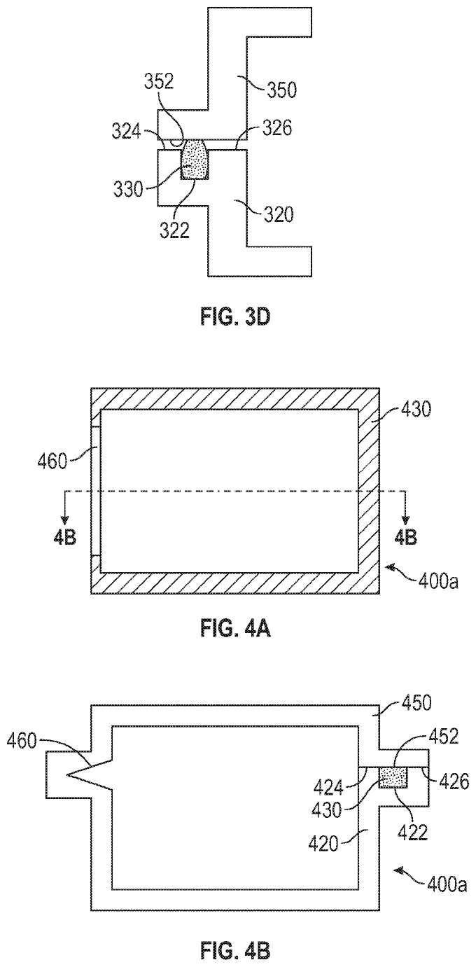

Referring now to FIG. 3, a schematic cross-sectional view is provided of a portion of an article 320 having a surface 322 onto which a flowable composition 310 is being deposited to make a foam gasket. Optionally, the flowable composition 310 is dispensed using a nozzle 340, which may be attached to a mixer that is configured to combine more than one component to form the flowable composition 310 from separate material sources A and B. FIG. 3B is a schematic cross-sectional view of the portion of the article 320 of FIG. 3A in which the foam gasket 330 is forming by foaming (and polymerization and/or crosslinking) of the flowable composition 310. Often, the foam gasket 330 is formed in 5 minutes or less following deposition of the flowable composition 310 on the surface 322, such as in 3 to 5 minutes. In some embodiments, the foam gasket 330 adheres to the article surface 322, whereas in other embodiments the foam gasket 330 does not adhere to the article surface 322 but rather may readily be removed from the article after formation without damaging the foam gasket 330 or the article 320. The portion of the article 320 is configured to further comprise a first mating surface 324 and a second mating surface 326, wherein the foam gasket 330 is disposed between the two mating surfaces 324, 326. The initial thickness of the foam gasket 330 is larger than the height of each of the two mating surfaces 324, 326, protruding above the two surfaces. FIG. 3C is a schematic cross-sectional view of the portion of the article 320 of FIG. 3B following mating of the surface 322 with a portion of a second surface 352 of a second portion of the article 350. The second surface 322 contacts each of the first mating surface 324 and the second mating surface 326 of the portion of the article 320, compressing the foam gasket 330 in between the portion of the article 320 and the second portion of the article 350, i.e., decreasing the thickness of the foam gasket 330.

FIG. 3D is a schematic cross-sectional view of the article of FIG. 3C showing recovery of the foam gasket 330 upon separation of the mated surfaces 352 and 324, 326. Advantageously, foam gaskets according to at least certain embodiments of the present disclosure exhibit sufficient shape recovery following release of a compression force to return to its initial thickness, or within 90%, or within 80%, or within 70% of its initial thickness.

Various methods for dispensing flowable compositions are suitable for at least certain embodiments of the method. More particularly, the method may include heating the flowable composition in an oven and/or an extruder. In certain embodiments, the flowable composition is mixed in an extruder, heated in an extruder, or both mixed and heated in an extruder. Typically, an extruder comprises at least a barrel, a neck tube, and a die, and may have be a single screw extruder or a twin screw extruders. One suitable twin screw extruder is described in the examples below. As an alternative to using a twin screw extruder, the flowable composition may be compounded and extruded in a first step at a temperature below activation of the chemical blowing agent, and then the flowable composition may be fed through an applicator that provides heat in either the barrel or nozzle to soften the flowable composition and activate the blowing agent during dispensing.

Typically, the flowable composition is heated at ambient pressure. The flowable composition is heated, usually by subjection to a temperature of 40° C. or greater, 50° C., 60° C., 75° C., 90° C., 100° C., 120° C., 130° C., 140° C., 150° C., 160° C., 170° C., or 180° C. or greater; and 500° C. or less, 475° C., 450° C., 425° C., 400° C., 375° C., 350° C., 325° C., 300° C., 275° C., 250° C., 230° C., 210° C., 200° C., 190° C., or 180° C. or less; such as ranging from 40° C. to 475° C., 40° C. to 350° C., 140° C. to 310° C., 250° C. to 420° C., or 180° C. to 300° C., inclusive. When the flowable composition comprises a thermoplastic silicone polymer, flowable composition is subjected to a minimum temperature of 100° C. when heated, such as 100° C. or greater, 120° C., 130° C., 140° C., 150° C., 160° C., 170° C., or 180° C. or greater; and 500° C. or less, 475° C., 450° C., 425° C., 400° C., 375° C., 350° C., 325° C., 300° C., 275° C., 250° C., 230° C., 210° C., 200° C., 190° C., or 180° C. or less.

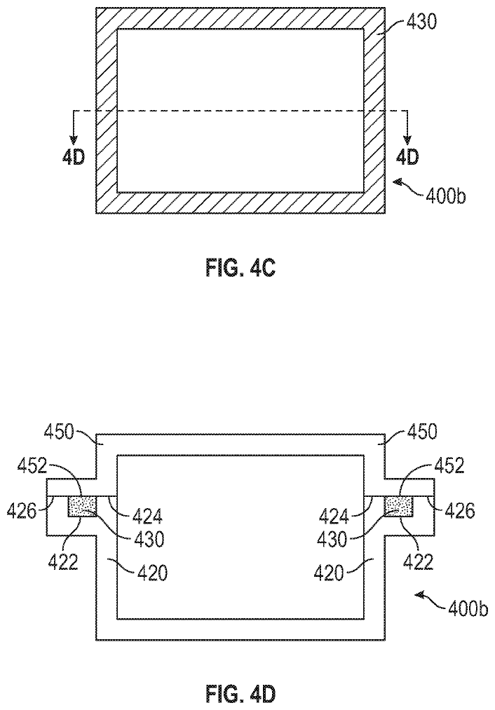

In some embodiments, the first surface of an article is a portion of one half of a clamshell structure and the second surface of an article is a portion of the other half of a clamshell structure, in which the two clamshell structures are configured to mate, with the foam gasket providing a resilient seal between the two halves of the clamshell structure. Referring to FIG. 4A, a schematic top view of the foam gasket 430 disposed on a top surface of an article 400a, having a classic clamshell structure. FIG. 4A also shows a hinge 460 disposed along a portion of one wall of the article 400a. FIG. 4B is a schematic cross-sectional side view is provided of an article 400a of FIG. 4A, taken along line 4b-4b. The article 400a includes a first portion of an article 420 having a foam gasket 430 disposed on a surface 422 of the article 420. A portion of a second surface 452 of a second portion of the article 450 is in contact with the foam gasket 430 and each of a first mating surface 424 and a second mating surface 426 of the portion of the article 420, compressing the foam gasket 430 in between the first portion of the article 420 and the second portion of the article 450. The article 400a further comprises a hinge 460 that is movable between an open configuration and a closed configuration. The hinge is in a closed configuration when the first portion of the article 420 and the second portion of the article 450 are mated (as shown in FIG. 4B), and in an open configuration when the first portion of the article 420 and the second portion of the article 450 are separate from each other (not shown).

FIG. 4C is a schematic top view of another article 400b, showing that a foam gasket 430 extends around the entire perimeter of the article 400b. FIG. 4D is a cross-sectional side view of the article 400b of FIG. 4C, taken along line 4d-4d, having a variation of a classic clamshell structure in which two portions of the article 400b are completely separable from each other. The article 400b includes a first portion of an article 420 having the foam gasket 430 disposed on a surface 422 of the article 420. A portion of a second surface 452 of a second portion of the article 450 is in contact with the foam gasket 430 and each of a first mating surface 424 and a second mating surface 426 of the portion of the article 420, compressing the foam gasket 430 in between the first portion of the article 420 and the second portion of the article 450.

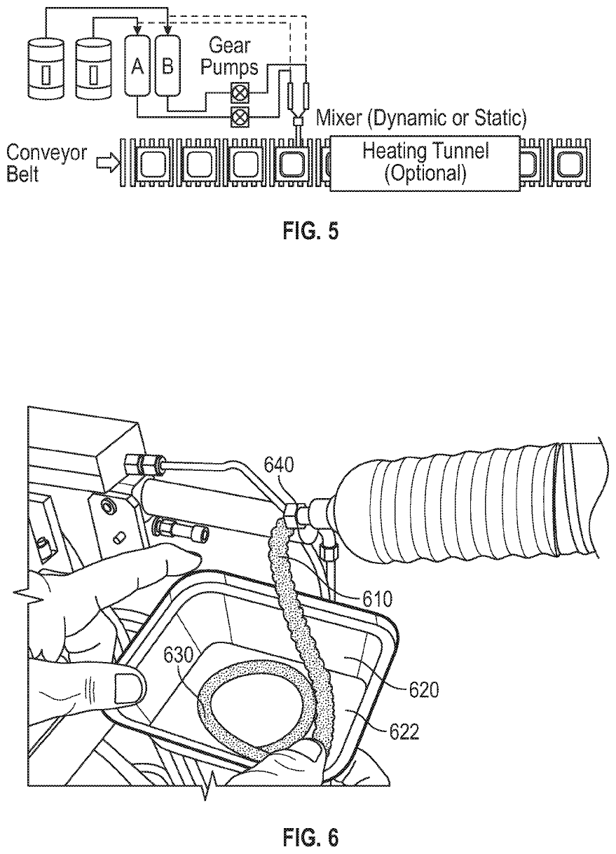

Advantageously, the ability to form a silicone foam gasket in under five minutes enables the manufacturing capability of an assembly line process for preparing an article including a foam gasket. FIG. 5 is a schematic diagram of such an assembly line process, including a mixer (either dynamic or static) that is configured to combine more than one component to form a flowable composition from separate material sources A and B, which are delivered to the mixer via gear pumps from bulk material containers. Alternatively, the flowable composition may be premixed and the mixer maintains the homogeneity of the mixture. After mixing and deposition of the flowable composition onto an article, the article is moved past the mixer by a conveyor belt and optionally heated in a heating tunnel to initiate foaming or continue foaming of the flowable composition to form a foam gasket, if all the materials present in the article can safely be exposed to elevated temperatures. Additionally, the flowable composition on the article may be subjected to UV radiation (not shown) to initiate a UV-activated initiator.

In some embodiments of the method (of the third aspect), the crosslinkable silicone component comprises a silicone thermoplastic polymer. Referring back to FIG. 1, in embodiments comprising a silicone thermoplastic polymer, the method further comprises (optional) Step 130b, wherein the dispensing of the flowable composition comprises melting, mixing, blowing, and coating at elevated temperature of the flowable composition, wherein the crosslinkable silicone component comprises a silicone thermoplastic polymer; and wherein the solidifying the flowable composition on the surface of the article comprises physical crosslinking of the silicone thermoplastic polymer to form the foam gasket on the surface of the article. The melt flowing index and physical crosslinking is mainly determined by the characteristics of hard segments of thermoplastic polymer. The chemical blowing agent is as described in detail above with respect to the first aspect. Referring to FIG. 6, a photograph is provided of a silicone thermoplastic polymer composition 610 forming a foam composition 630 upon being dispensed from a hotmelt dispenser 640 attached to a twin screw extruder and deposited onto a surface 622 of an aluminum tray 622. This illustrates the ability to quickly form a foam from a silicone material without requiring a long thermal cure. It was surprisingly discovered that the foam prepared from crosslinking a silicone thermoplastic polymer did not collapse, but rather remained a foam composition.

Suitable silicone thermoplastic polymers include polyorganosiloxane polyoxamide copolymers, which are described, for instance, in co-owned U.S. Pat. Nos. 7,501,184 (Leir et al.) and 8,765,881 (Hays et al.), U.S. Application Publication No. 2011/0071270 (Hays et al) incorporated herein by reference in their entireties, silicone polyamides which are described, for instance, in co-owned U.S. Pat. No. 10,604,0614 (Kalgutkar et al), U.S. Application Publication Nos. 2008/0318057 and 2008/0318058 (Sherman et al), and polyorganosiloxane polyurea copolymers which are described, for instance, in co-owned PCT Publication No. 1997/040103 (Paulick et al) and EP0380236 (Leir).

Optionally, the flowable composition further comprises at least one of a physical blowing agent, expandable microspheres, a crosslinking agent, or at least one filler selected from silica, glass bubbles, talc, flame retardants, and/or pigments. Each of these optional components is as described in detail above with respect to the first aspect.

### Foam Gaskets and Articles

In a fourth aspect, a foam gasket is provided. The foam gasket includes a foamed silicone thermoplastic polymer matrix and fragments of a chemical blowing agent. Often, the silicone thermoplastic polymer matrix is formed of a polyorganosiloxane copolymer, such as a polyorganosiloxane block copolymer. Fragments of a chemical blowing agent used to foam the silicone thermoplastic polymer matrix are as described above, as well as how to determine their presence. There may potentially also be some chemical blowing agent particles remaining in the foam composition that did not decompose during the foaming process, which may be identified by image analysis of a cross-section of the foam gasket using SEM. Suitable chemical blowing agents include those described in detail above with respect to the first aspect.

Optionally, the foam gasket further comprises at least one of expandable microspheres or at least one filler selected from silica, glass bubbles, talc, flame retardants, and/or pigments. Each of these optional components is as described in detail above with respect to the first aspect.

In at least certain embodiments, the foam gasket advantageously has an exterior surface that is non-tacky. Whether or not an exterior surface is non-tacky may be determined by contacting a polyethylene terephthalate (PET) film with the exterior surface using hand pressure and then peeling the film off the surface. If no residue attaches to the PET film, the foam gasket is determined to be “non-tacky” and if any residue attaches to the PET the foam gasket is determined to be “tacky”. The level of non-tackiness may also be quantified by a texture analyzer according to a procedure described in ASTM D2979-95. The silicone thermoplastic polymer assists in providing a non-tacky surface on at least a portion of the exterior of the foam gasket. For instance, the foam gasket may be adhered to an article surface onto which it was formed, but (at least substantially) completed crosslinking prior to coming into contact with any other article surface and exhibits a non-tacky surface. This is particularly advantageous when the gasket is used with an article that is designed to be opened after having been closed (e.g., with the foam gasket compressed between multiple article surfaces while closed). In certain embodiments, the foam gasket does not adhere to an article surface onto which it was formed. In such embodiments, the foam gasket may readily be removed from the article after formation.

In a fifth aspect, an article is provided. The article comprises:
a) a first surface;
b) a second surface configured to mate with the first surface, such that when the first surface and the second surface are mated, the article has a closed clamshell structure; and
c) a foam gasket disposed on the first surface, wherein the foam gasket comprises a foamed silicone thermoplastic polymer matrix.

By “mating” is meant that the first surface and second surface at least partially contribute to forming a closed structure; there may be one or more additional surfaces in the article that participate in forming the closed structure. For instance, referring back to FIG. 3, the first surface 322 of the article 320 on which the foam gasket 330 is disposed further comprises a first mating surface 324 and a second mating surface 326 that each extend from the first surface 322 in an orthogonal direction to the first surface 322. The foam gasket 330 is disposed between the two mating surfaces 324, 326 and the second surface 352 contacts the two mating surfaces 324, 326 to complete the mating of the first surface 322 with the second surface 352 and enclose the foam gasket. Similarly, FIG. 4D shows a closed article 400b comprising a foam gasket 430 disposed on a surface 422 and a second surface 452 is in contact with the foam gasket 430 as well as each of a first mating surface 424 and a second mating surface 426. The surfaces 422, 452, 424, and 426 surround and compress the foam gasket 430 to effectively mate the first surface and the second surface. Preferably, after the first surface is mated with the second surface, separation of the second surface from the first surface leaves no residue of the foam gasket on the second surface. In select embodiments, the article comprises or consists of a battery pack.

Various embodiments are provided that include compositions, foam compositions, foam gaskets, methods of making foam gaskets, and articles.

In a first embodiment, the present disclosure provides a composition. The composition comprises a) a chemical blowing agent; b) a silicone component comprising an average of more than one free-radically reactive group; and c) a free-radical initiator.

In a second embodiment, the present disclosure provides a composition according to the first embodiment, wherein the free-radically reactive groups of the silicone component comprise ethylenically-unsaturated groups.

In a third embodiment, the present disclosure provides a composition according to the first embodiment of the second embodiment, wherein the silicone component comprises a silicone (meth)acrylate.

In a fourth embodiment, the present disclosure provides a composition according to any of the first through third embodiments, wherein the silicone component comprises a multifunctional silicone (meth)acrylate.

In a fifth embodiment, the present disclosure provides a composition according to any of the first through fourth embodiments, wherein the silicone component comprises a monofunctional silicone (meth)acrylate.

In a sixth embodiment, the present disclosure provides a composition according to any of the first through fifth embodiments, wherein the silicone component comprises an oligomer having two to nine repeat units.

In a seventh embodiment, the present disclosure provides a composition according to any of the first through fifth embodiments, wherein the silicone component comprises a polymer having ten to ninety-nine repeat units.

In an eighth embodiment, the present disclosure provides a composition according to any of the first through fifth embodiments, wherein the silicone component comprises a polymer having 100 repeat units or greater, 500 repeat units or greater, 1,000 repeat units or greater, 2,000 repeat units or greater, 3,000 repeat units or greater, 4,000 repeat units or greater, 5,000 repeat units or greater, 6,000 repeat units or greater, 7,000 repeat units or greater; and 10,000 repeat units or less, 9,000 repeat units or less, or 8,000 repeat units or less.

In a ninth embodiment, the present disclosure provides a composition according to any of the first through eighth embodiments, wherein the silicone component comprises an average of free-radically reactive groups of 1.1 or more, 1.3 or more, 1.5 or more, 1.7 or more, 1.9 or more, 2.0 or more, 2.5 or more, 3.0 or more, 3.5 or more, or 4.0 or more.

In a tenth embodiment, the present disclosure provides a composition according to any of the first through ninth embodiments, wherein the chemical blowing agent comprises an unencapsulated chemical blowing agent.

In an eleventh embodiment, the present disclosure provides a composition according to the tenth embodiment, wherein the unencapsulated chemical blowing agent comprises a synthetic azo-based compound.

In a twelfth embodiment, the present disclosure provides a composition according to any of the first through eleventh embodiments, wherein the chemical blowing agent comprises an encapsulated chemical blowing agent comprising a shell around the chemical blowing agent.

In a thirteenth embodiment, the present disclosure provides a composition according to the twelfth embodiment, wherein the shell of the encapsulated chemical blowing agent comprises an uncrosslinked thermoplastic material.

In a fourteenth embodiment, the present disclosure provides a composition according to any of the first through thirteenth embodiments, wherein the chemical blowing agent comprises an azocompound, a diazocompound, a sulfonyl hydrazide, a sulfonyl semicarbazide, a tetrazole, a nitrosocompound, an acyl sulfonyl hydrazide, a hydrazone, a thiatriazole, an azide, a sulfonyl azide, an oxalate, a thiatrizine dioxide, or any combination thereof.

In a fifteenth embodiment, the present disclosure provides a composition according to any of the first through fourteenth embodiments, wherein the free-radical initiator comprises a UV radiation-activated initiator.

In a sixteenth embodiment, the present disclosure provides a composition according to any of the first through fifteenth embodiments, wherein the free-radical initiator comprises a thermally-activated initiator.

In a seventeenth embodiment, the present disclosure provides a composition according to any of the first through sixteenth embodiments, wherein the free-radical initiator comprises photoinitiator groups selected from acyl phosphine oxide, alkyl amine acetophenone, benzil ketal, xanthone, pentadione, thioxanthrequinone, 2,3-butanedione, phenanthrenequinone, ethylanthraquinone, 1,4-chrysenequinone, camphorequinone, pyrene, hydroxy-acetophenone, benzophenone, organic or inorganic peroxide, a persulfate, titanocene complex, azo, or combinations thereof.

In an eighteenth embodiment, the present disclosure provides a composition according to any of the first through seventeenth embodiments, further comprising at least one physical blowing agent.

In a nineteenth embodiment, the present disclosure provides a composition according to any of the first through eighteenth embodiments, further comprising expandable microspheres.

In a twentieth embodiment, the present disclosure provides a composition according to any of the first through nineteenth embodiments, further comprising at least one monomer that does not contain a silicone group.

In a twenty-first embodiment, the present disclosure provides a composition according to any of the first through twentieth embodiments, further comprising at least one filler selected from silica, glass bubbles, talc, flame retardants, pigments, and any combination thereof.

In a twenty-second embodiment, the present disclosure provides a composition according to any of the first through twenty-first embodiments, further comprising a crosslinking agent comprising at least one multifunctional monomer, oligomer, or polymer that does not contain a silicone group.

In a twenty-third embodiment, the present disclosure provides a composition according to any of the first through twenty-second embodiments, further comprising an organosilane monomer.

In a twenty-fourth embodiment, the present disclosure provides a foam composition. The foam composition comprises a foamed silicone thermoset polymer matrix; fragments of a free-radical initiator; and fragments of a chemical blowing agent.

In a twenty-fifth embodiment, the present disclosure provides a foam composition according to the twenty-fourth embodiment, exhibiting a compression set of 50% or less, 40% or less, 30% or less, or 20% or less.

In a twenty-sixth embodiment, the present disclosure provides a foam composition according to the twenty-fourth embodiment or the twenty-fifth embodiment, further comprising at least one chemical blowing agent.

In a twenty-seventh embodiment, the present disclosure provides a foam composition according to any of the twenty-fourth through twenty-sixth embodiments, comprising a closed cell foam.

In a twenty-eighth embodiment, the present disclosure provides a foam composition according to any of the twenty-fourth through twenty-sixth embodiments, comprising an open cell foam

In a twenty-ninth embodiment, the present disclosure provides a foam composition according to any of the twenty-fourth through twenty-eighth embodiments, exhibiting an average cell size of 2 millimeter (mm) to 1 micrometer (m).

In a thirtieth embodiment, the present disclosure provides a foam composition according to any of the twenty-fourth through twenty-ninth embodiments, exhibiting a unimodal cell size distribution.

In a thirty-first embodiment, the present disclosure provides a foam composition according to any of the twenty-fourth through twenty-ninth embodiments, exhibiting a multimodal cell size distribution.

In a thirty-second embodiment, the present disclosure provides a foam composition according to any of the twenty-fourth through thirty-first embodiments, exhibiting a specific gravity of less than 1, less than 0.8, or less than 0.6.

In a thirty-third embodiment, the present disclosure provides a foam composition according to any of the twenty-fourth through thirty-second embodiments, further comprising at least one filler selected from silica, glass bubbles, talc, flame retardants, pigments, and any combination thereof.

In a thirty-fourth embodiment, the present disclosure provides a foam composition according to any of the twenty-fourth through thirty-third embodiments, wherein the silicone thermoset polymer matrix comprises a silicone (meth)acrylate polymer.

In a thirty-fifth embodiment, the present disclosure provides a method of making a foam gasket. The method comprises a) dispensing a flowable composition onto a surface of an article; and b) solidifying the flowable composition to form the foam gasket on the surface of the article. The composition includes 1) a chemical blowing agent; and 2) at least one crosslinkable silicone component. The flowable composition is dispensed at a temperature sufficient to activate the chemical blowing agent.

In a thirty-sixth embodiment, the present disclosure provides a method according to the thirty-fifth embodiment, wherein the crosslinkable silicone component comprises an average of more than one free-radically reactive group wherein the flowable composition further comprises 3) a free-radical initiator; and wherein the solidifying step comprises exposing the flowable composition on the surface of the article to at least one of UV radiation or heat to activate the free-radical initiator.

In a thirty-seventh embodiment, the present disclosure provides a method according to the thirty-sixth embodiment, wherein the flowable composition is exposed to UV radiation.

In a thirty-eighth embodiment, the present disclosure provides a method according to the thirty-sixth embodiment or the thirty-seventh embodiment, wherein the flowable composition is exposed to heat.

In a thirty-ninth embodiment, the present disclosure provides a method according to any of the thirty-sixth through thirty-eighth embodiments, wherein the flowable composition is simultaneously exposed to both UV radiation and heat.

In a fortieth embodiment, the present disclosure provides a method according to any of the thirty-sixth through thirty-eighth embodiments, wherein the flowable composition is exposed to each of UV radiation and heat, in sequence.

In a forty-first embodiment, the present disclosure provides a method according to any of the thirty-fifth through fortieth embodiments, wherein the flowable composition exhibits a viscosity at the dispensing temperature of 10,000 to 1,000,000 centipoises (cP).

In a forty-second embodiment, the present disclosure provides a method according to any of the thirty-fifth through forty-first embodiments, wherein the flowable composition is the composition according to any of the first through twenty-third embodiments.

In a forty-third embodiment, the present disclosure provides a method according to any of the thirty-fifth through forty-second embodiments, wherein the article comprises an enclosed article.

In a forty-fourth embodiment, the present disclosure provides a method according to any of the thirty-fifth through forty-third embodiments, wherein the article is a battery pack.

In a forty-fifth embodiment, the present disclosure provides a method according to the thirty-fifth embodiment, wherein a) the dispensing the flowable composition comprises melting, mixing, blowing, and coating at elevated temperature of the flowable composition and wherein the crosslinkable silicone component comprises a silicone thermoplastic polymer; and b) wherein the solidifying the flowable composition on the surface of the article comprises physical crosslinking of silicone thermoplastic polymer to form the foam gasket on the surface of the article.

In a forty-sixth embodiment, the present disclosure provides a method according to the forty-fifth embodiment, wherein the silicone thermoplastic polymer comprises a polyorganosiloxane block copolymer, such as silicone polyoxamide.

In a forty-seventh embodiment, the present disclosure provides a method according to the forty-fifth embodiment or the forty-sixth embodiment, wherein the chemical blowing agent comprises an encapsulated chemical blowing agent comprising a shell around the chemical blowing agent.

In a forty-eighth embodiment, the present disclosure provides a method according to the forty-seventh embodiment, wherein the shell of the encapsulated chemical blowing agent comprises an uncrosslinked thermoplastic material.

In a forty-ninth embodiment, the present disclosure provides a method according to any of the forty-fifth through forty-eighth embodiments, wherein the chemical blowing agent comprises a diazocompound, a sulfonyl hydrazide, a tetrazole, a nitrosocompound, an acyl sulfonyl hydrazide, a hydrazone, a thiatriazole, an azide, a sulfonyl azide, an oxalate, a thiatrizine dioxide, or any combination thereof.

In a fiftieth embodiment, the present disclosure provides a method according to any of the forty-fifth through forty-ninth embodiments, wherein the flowable composition further comprises at least one physical blowing agent.

In a fifty-first embodiment, the present disclosure provides a method according to any of the forty-fifth through fiftieth embodiments, wherein the flowable composition further comprises expandable microspheres.

In a fifty-second embodiment, the present disclosure provides a method according to any of the forty-fifth through fifty-first embodiments, wherein the flowable composition further comprises at least one filler selected from silica, glass bubbles, talc, flame retardants, pigments, and any combination thereof.

In a fifty-third embodiment, the present disclosure provides a method according to any of the forty-fifth through fifty-second embodiments, wherein the flowable composition further comprises a crosslinking agent comprising at least one multifunctional monomer, oligomer, or polymer that does not contain a silicone group.

In a fifty-fourth embodiment, the present disclosure provides a method according to any of the forty-fifth through fifty-third embodiments, wherein the article comprises a battery pack.

In a fifty-fifth embodiment, the present disclosure provides a foam gasket. The foam gasket comprises a foamed silicone thermoplastic polymer matrix and fragments of a chemical blowing agent.

In a fifty-sixth embodiment, the present disclosure provides a foam gasket according to the fifty-fifth embodiment, wherein the silicone thermoplastic polymer comprises a polyorganosiloxane copolymer.

In a fifty-seventh embodiment, the present disclosure provides a foam gasket according to the fifty-fifth embodiment or the fifty-sixth embodiment, further comprising a chemical blowing agent.

In a fifty-eighth embodiment, the present disclosure provides a foam gasket according to the fifty-seventh embodiment, wherein the chemical blowing agent comprises an encapsulated chemical blowing agent comprising a shell around the chemical blowing agent.

In a fifty-ninth embodiment, the present disclosure provides a foam gasket according to the fifty-eighth embodiment, wherein the shell of the encapsulated chemical blowing agent comprises an uncrosslinked thermoplastic material.

In a sixtieth embodiment, the present disclosure provides a foam gasket according to any of the fifty-seventh through fifty-ninth embodiments, wherein the chemical blowing agent comprises a diazocompound, a sulfonyl hydrazide, a tetrazole, a nitrosocompound, an acyl sulfonyl hydrazide, a hydrazone, a thiatriazole, an azide, a sulfonyl azide, an oxalate, a thiatrizine dioxide, or any combination thereof.

In a sixty-first embodiment, the present disclosure provides a foam gasket according to any of the fifty-fifth through sixtieth embodiments, further comprising expandable microspheres.

In a sixty-second embodiment, the present disclosure provides a foam gasket according to any of the fifty-fifth through sixty-first embodiments, further comprising at least one filler selected from silica, glass bubbles, talc, flame retardants, pigments, and any combination thereof.

In a sixty-third embodiment, the present disclosure provides a foam gasket according to any of the fifty-fifth through sixty-second embodiments, wherein an exterior surface of the foam gasket is non-tacky.

In a sixty-fourth embodiment, an article is provided. The article comprises a) a first surface; b) a second surface configured to mate with the first surface, such that when the first surface and the second surface are mated, the article has a closed clamshell structure; and c) a foam gasket disposed on the first surface. The foam gasket comprises a foamed silicone thermoplastic polymer matrix.

In a sixty-fifth embodiment, the present disclosure provides an article according to the sixty-fourth embodiment, comprising a battery pack.

In a sixty-sixth embodiment, the present disclosure provides an article according to the sixty-fourth embodiment or the sixty-fifth embodiment, wherein, after the first surface is mated with the second surface, separation of the second surface from the first surface leaves no residue of the foam gasket on the second surface.

The following Examples are set forth to describe additional features and embodiments of the invention. All parts are by weight unless otherwise indicated.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise noted or readily apparent from the context, all parts, percentages, ratios, etc. in the Examples and the rest of the specification are by weight.

Unless otherwise noted or readily apparent from the context, all parts, percentages, ratios, etc. in the Examples and the rest of the specification are by weight.

TABLE 1
Materials Used in the Examples

| Abbre- | |
|---|---|
| viation | Description and Source |
| SPOx | Silicone polyoxamide, obtained from Wacker Chemie AG, |
| | Burghausen, Germany |
| Azo | 1,1′-azodicarboxamide, obtained from Sigma Aldrich, St. |
| | Louis, MO |
| PTSH | Hydroxypropyl starch, obtained from Sigma Aldrich, St. |
| | Louis, MO |
| HPS | Hydroxypropyl starch, obtained under the trade designation |
| | “LYCOAT RS780” from Roquette, Keokuk, IA |
| PVP | Poly(vinylpyrrolidone), obtained as “PVP k30” from TCI, |
| | Portland, OR |
| SiAc | Silicone acrylate, multifunctional, obtained under the trade |
| | designation “TEGO RC902” from Evonik, Essen, Germany |
| SiMac | Silicone acrylate, monofunctional, obtained from 3M, St. |
| | Paul, MN |
| TetraAc | Ditrimethylol propane tetraacrylate, obtained under the trade |
| | designation “EBERCRYL 140” from Allnex, Frankfurt, |
| | Germany |
| PEA | 2-Phenoxyethyl acrylate, obtained under the trade designation |
| | “SR339” from Sartomer Americas, Exton, PA |
| FSi | Fumed silica, obtained under the trade designation “AEROSIL |
| | 8200” from Evonik, Essen, Germany |
| A18 | Photoinitiator A18, obtained under the trade designation “TEGO |
| | A18” from Evonik, Essen, Germany |
| Vazo | 2,2′-azobis(2,4-dimethylvaleronitrile), obtained under the trade |
| | designation “VAZO 52” from Miller-Stephenson, Danbury, CT |

### Test Methods

### Scanning Electron Microscopy (SEM)

The cell structure of the flexible PLA foams was imaged by SEM using a JEOL JSM-6010LA SEM (JEOL Ltd., Tokyo, JP). Samples were prepared using a #10 scalpel to cut a thin slice of the foamed article. The slice was mounted on a JEOL SEM stage and sputter coating with Au/Pd for 30 seconds at 20 mA in a Denton Vacuum Desk V coating system (Denton Vacuum, LLC, Moorestown, NJ).

### Compression Test

A small strip of the specimen was cut from the sample out of the extruder. The specimen thickness was measured to determine a pre-compression thickness. The specimen was then compressed to 3 inches and placed in an oven at either room temperature, 50° C., or 85° C. for 24 hours. The specimen was removed from the oven and released from the compression pressure and measured immediately, after 15 minutes, and after 24 hours after release. The original thicknesses and the post-compression thicknesses, in units of inches, are reported in Tables 3-5.

### Sample Preparation

### Spray Drying to Produce Azo Particles

A slurry of polymer and chemical blowing agent was dried with a Mini Spray Dryer B-290 by Buchi Corporation (headquartered in New Castle, DE). Room air (approximately 21° C. and 50% humidity) was provided as the bulk drying gas, which was then heated via an electric heater and carried through the drying chamber (entered through the top and exited through the bottom) and finally to a cyclone and a baghouse before being exhausted. The drying gas flow rate was unknown. The bulk drying gas temperature at the chamber inlet was 165-170° C., while the outlet temperature was 72-80° C. The slurry was provided at 10 (±3) grams per minute (g/min) via the peristaltic pump using a silicone tubing line and the slurry was atomized vertically downward.

### Spray Drying to Produce PTSH Particles

A slurry of polymer and chemical blowing agent was dried with a Mini Spray Dryer B-290 by Buchi Corporation (headquartered in New Castle, DE). Room air (approximately 21° C. and 50% humidity) was provided as the bulk drying gas, which was then heated via an electric heater and carried through the drying chamber (entered through the top and exited through the bottom) and finally to a cyclone and a baghouse before being exhausted. The drying gas flow rate was unknown. The bulk drying gas temperature at the chamber inlet was 128-135° C., while the outlet temperature was 77-86° C. The slurry was provided at 8 (±3) grams per minute (g/min) via the peristaltic pump using a silicone tubing line and the slurry was atomized vertically downward.

### Preparatory Example 1 (PE-1)

25 g of Azo powder was added to a solution of 75 g HPS in 300 g water to give a 25 wt. % solids suspension. The suspension was further mixed with a high shear mixer (T50 digital Ultra Turrax, IKA) at 4000-5000 rpm for 2 minutes (min) then strained through a sieve with 150 um mesh to remove any large particles. This polymer mixture was then spray dried (method described above) to put a polymer shell around the particles. 33 g of free-flowing powders were obtained (at 33% yield). The resulting capsules contained 30 wt. % of Azo.

### Preparatory Example 2 (PE-2)

9.8 g of Azo powder was added to a solution of 89 g HPS in 665 g water to give a 13 wt. % solids suspension. The suspension was further mixed with a high shear mixer (T50 digital Ultra Turrax, IKA) at 4000-5000 rpm for 2 min then strained through a sieve with 150 μm mesh to remove any large particles. This polymer mixture was then spray dried (method described above) to put a polymer shell around the particles. 20 g of free-flowing powders were obtained (at 20% yield). The resulting capsules contained 13 wt. % of Azo.

### Preparatory Example 3 (PE-3)

6.3 g of PTSH powder was added to a solution of 25 g PVP in 75 g water to give a 13 wt. % solids suspension. The suspension was further mixed with a high shear mixer (T50 digital Ultra Turrax, IKA) at 4000 rpm for 2 min then strained through a sieve with 150 μm mesh to remove any large particles. This polymer mixture was then spray dried (method described above) to put a polymer shell around the particles. 15 g of free-flowing powders were obtained (at 15% yield). The resulting capsules contained 22 wt. % of PTSH.

### General Procedure 1 (GP-1)—Foam Extrusion Using Azo-based Blowing Agents

A twin screw extruder (screw diameter: 30 mm; ratio of screw length to diameter: 17; Zone 1: 250° F.; Zones 2, 3, and 4: 300° F.; Zones 5 and 6: 320° F.; Zone 7: 350° F.; Zone 8: variable ° F.) was used to compound and foam a mixture of SPOx and azo-based blowing agents. The resin was compounded with a residence time of 1.5 min at 150 rpm and pumped out using a gear pump 25 (Zone 7). The resin was extruded directly out of the hose (Zone 8) and the rope was collected on an aluminum tray.

### General Procedure 2 (GP-2)—Foam extrusion using PTSH-based blowing agents

A twin screw extruder (screw diameter: 30 mm; ratio of screw length to diameter: 17; Zones 1, 2, 3, 4 and 5: 220° F.; Zones 6: 240° F.; Zone 7: 250° F.; Zone 8: variable ° F.) was used to compound and foam a mixture of SPOx and PTSH-based blowing agents. The resin was compounded with a residence time of 1.5 min at 150 rpm and pumped out using a gear pump (Zone 7). The resin was extruded directly out of the hose (Zone 8) and the rope was collected on an aluminum tray.

### General Procedure 3 (GP-3)—Foaming Silicone Acrylates in an Oven

Vazo 52 was mixed with TetraAc or PEA using a THINKY Planetary Vacuum Mixer (THINKY U.S.A., INC., Laguna Hills, CA) at 2000 rpm for 1 min. This mixture was added to SiAc, SiMac, FSi, and/or A18 and the combined mixture was homogenized using a speed mixture (2000 rpm for 1 min). The combined mixture was added to an aluminum pan and set in an oven set to 250° F. for 2 min.

### General Procedure 4 (GP-4) —Foaming Silicone Acrylates Using UV Light

Vazo 52 was mixed with TetraAc or PEA using a THINKY Planetary Vacuum Mixer at 2000 rpm for 1 min. This mixture was added to SiAc, SiMac, FSi, and/or A18 and the combined mixture was homogenized using a speed mixture (2000 rpm for 1 min). The combined mixture was added to an aluminum pan and the pan was exposed to a Master Heat Gun (model GC-301A) until bubbles start to appear, then the pan was moved to a conveyor belt (10 ft/min) and passed under a Fusion UV System Inc (Gaithersburg, MD) D-type UV curing bulb under an inert nitrogen atmosphere (three passes).

### EXAMPLES

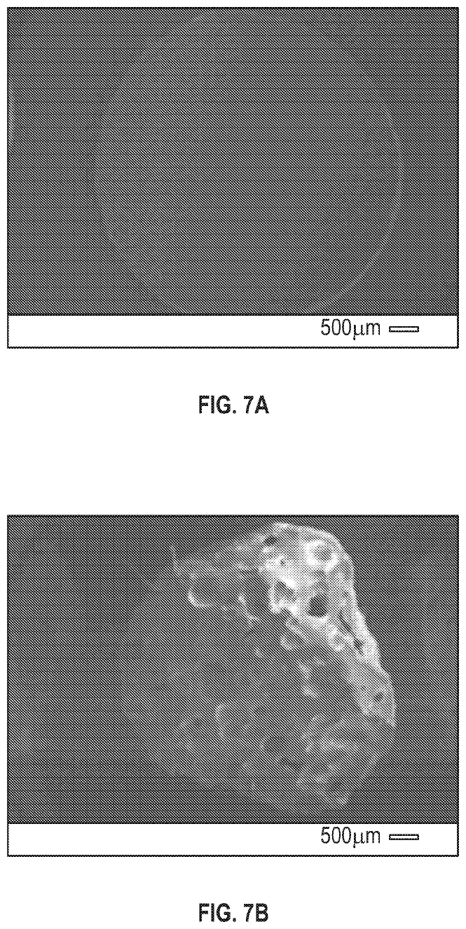

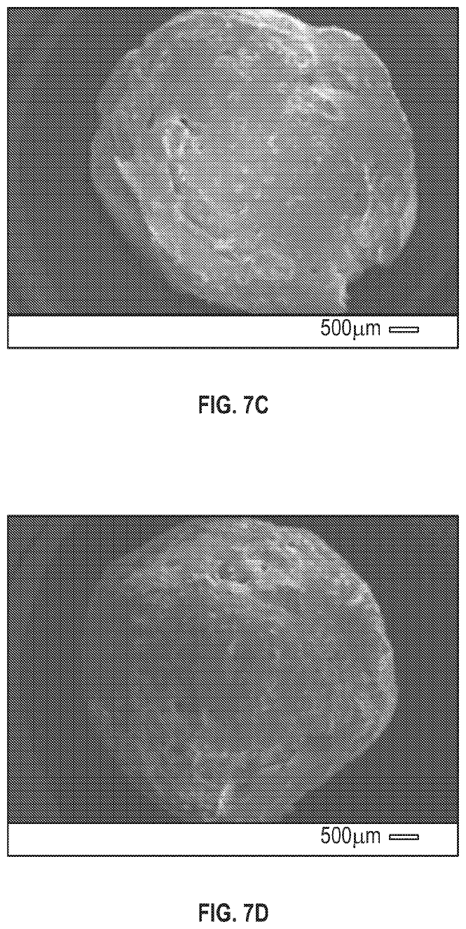

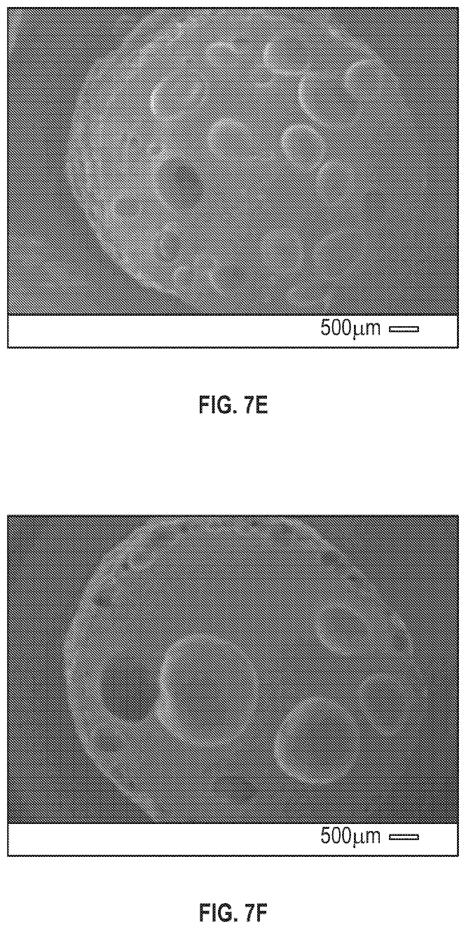

TABLE 2
Compositions Used to Extrude SPOx Samples and
Foaming Results.

| | | Blowing agent | Zone | | General | |
|---|---|---|---|---|---|---|
| Sam- | Blowing | concentration | 8 | | Pro- | |
| ple | agent | (wt. %) | (º F.) | Foam? | cedure | Figure |
| CE-1 | None | — | 380 | No | GP-1 | FIG. 7A |
| EX-1 | Azo | 1 | 410 | Yes | GP-1 | — |
| EX-2 | Azo | 0.5 | 410 | Yes | GP-1 | FIG. 7B |
| EX-3 | PE-1 | 1.2 | 410 | Yes | GP-1 | FIG. 7C |
| EX-4 | PE-2 | 4.9 | 410 | Yes | GP-1 | — |
| EX-5 | PE-2 | 2.9 | 410 | Yes | GP-1 | FIG. 7D |
| EX-6 | PTSH | 2 | 380 | Yes | GP-2 | FIG. 7E |
| EX-7 | PE-3 | 4 | 380 | Yes | GP-2 | FIG. 7F |
| EX-8 | PE-3 | 8 | 380 | Yes | GP-2 | — |

TABLE 3
Thickness Measured Immediately After Compression (T = 0 min)

| | | | Thickness | Thickness | Thickness |
|---|---|---|---|---|---|
| | | | (in) After | (in) After | (in) After |
| | Original | Compres- | Compres- | Compres- | Compres- |
| Sam- | Thickness | sion | sion at RT | sion at 50° | sion at 85° |
| ple | L0 (in) | Gap (in) | for 24 hr | C. for 24 hr | C. for 24 hr |
| CE-1 | 7 | 3 | 5.7 | 4 | 3.9 |
| EX-6 | 7.5 | 3 | 4.7 | 3.5 | 3.2 |
| EX-7 | 6.7 | 3 | 5.4 | 3.8 | 3.6 |
| EX-8 | 8.3 | 3 | 5.6 | 3.7 | 3.3 |

TABLE 4
Thickness Measured 15 minutes After Compression (T = 15 min)

| | | | Thickness | Thickness | Thickness |
|---|---|---|---|---|---|
| | | | (in) After | (in) After | (in) After |
| | Original | Compres- | Compres- | Compres- | Compres- |
| Sam- | Thickness | sion | sion at RT | sion at 50° | sion at 85° |
| ple | L0 (in) | Gap (in) | for 24 hr | C. for 24 hr | C. for 24 hr |
| CE-1 | 7 | 3 | 5.8 | 4.2 | 4.1 |
| EX-6 | 7.5 | 3 | 4.7 | 3.7 | 3.6 |
| EX-7 | 6.7 | 3 | 5.4 | 3.9 | 3.8 |
| EX-8 | 8.3 | 3 | 5.6 | 3.9 | 3.5 |

TABLE 5
Thickness Measured 24 hours After Compression (T = 24 hr)

| | | | Thickness | Thickness | Thickness |
|---|---|---|---|---|---|
| | | | (in) After | (in) After | (in) After |
| | Original | Compres- | Compres- | Compres- | Compres- |
| Sam- | Thickness | sion | sion at RT | sion at 50° | sion at 85° |
| ple | L0 (in) | Gap (in) | for 24 hr | C. for 24 hr | C. for 24 hr |
| CE-1 | 7 | 3 | 6.5 | 5.0 | 4.0 |
| EX-6 | 7.5 | 3 | 7.1 | 4.8 | 3.2 |
| EX-7 | 6.7 | 3 | 6.5 | 4.7 | 3.6 |
| EX-8 | 8.3 | 3 | 7.6 | 5.3 | 3.3 |

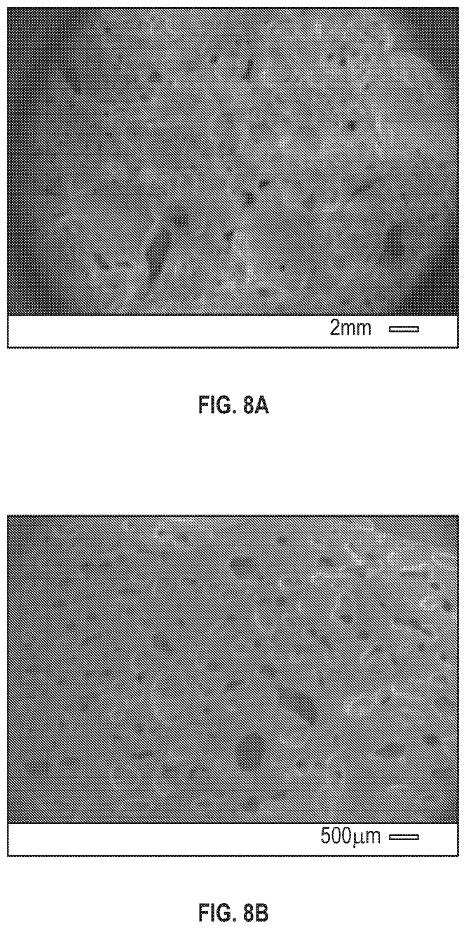

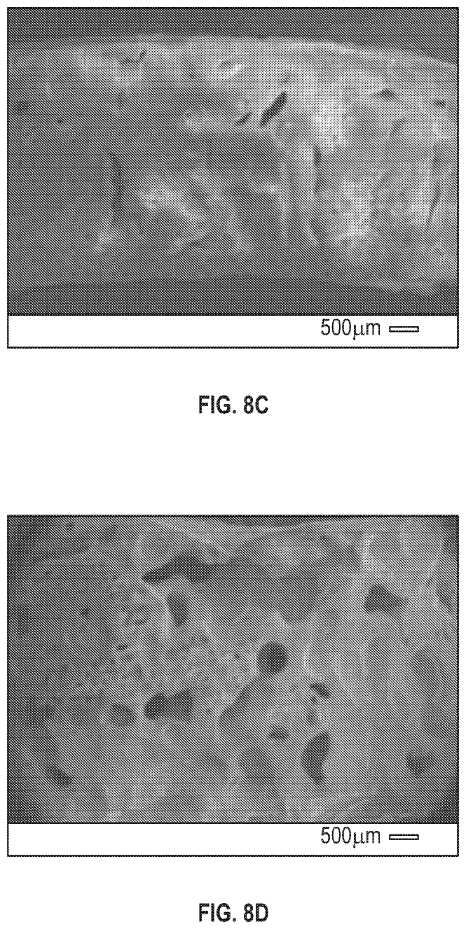

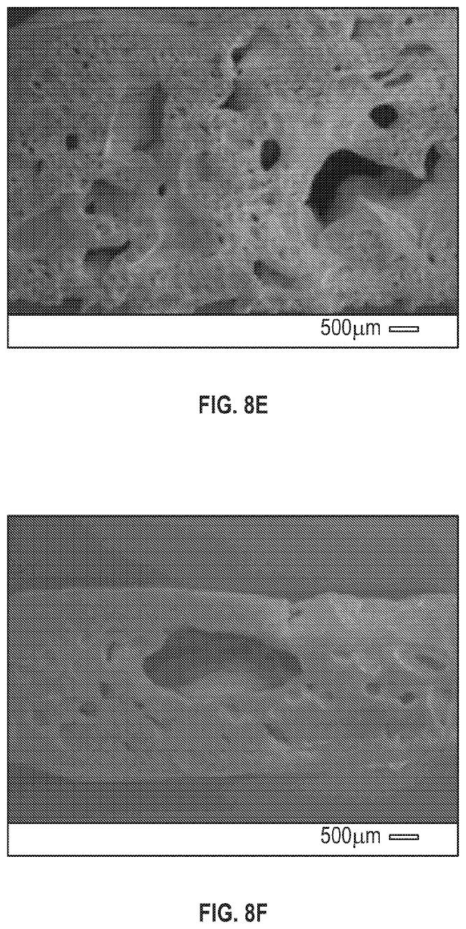

TABLE 6
Compositions of Silicone Acrylate Blends (all values in pph)

| | Vazo | | | | | | | General | |
|---|---|---|---|---|---|---|---|---|---|
| Sample | 52 | A18 | SiAc | SiMac | TetraAc | PEA | FSi | Procedure | Figure |
| EX-9 | 9 | 2 | 25.5 5 | 36.5 | 9 | 0 | 18 | GP-3 | FIG. 8A |
| EX-10 | 7.7 | 1.5 | 21.5 | 30.8 | 7.7 | 0 | 30.8 | GP-3 | FIG. 8B |
| EX-11 | 9 | 0 | 27.5 | 36.5 | 9 | 0 | 18 | GP-4 | FIG. 8D |
| EX-12 | 9 | 0.4 | 27.1 | 36.5 | 9 | 0 | 18 | GP-4 | FIG. 8E |
| EX-13a | 6.2 | 0.1 | 23 | 23 | 7.7 | 9.2 | 30.8 | GP-3 | FIG. 8C |
| EX-13b | 6.2 | 0.1 | 23 | 23 | 7.7 | 9.2 | 30.8 | GP-4 | FIG. 8F |

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A composition comprising:
a) a chemical blowing agent;
b) a silicone component comprising an average of more than one free-radically reactive group, wherein the silicone component comprises a multifunctional silicone (meth)acrylate; and
c) a free-radical initiator.

2. (canceled)

3. (canceled)

4. The composition of claim 1, further comprising at least one monomer that does not contain a silicone group, wherein the at least one monomer comprises a (meth)acrylate monomer.

5. The composition of claim 1, further comprising an organosilane monomer.

6. The composition of claim 1, further comprising at least one filler comprising silica.

7. A foam composition comprising a foamed silicone thermoset polymer matrix; fragments of a free-radical initiator; and fragments of a chemical blowing agent, wherein the silicone thermoset polymer matrix comprises a silicone (meth)acrylate polymer.

8. The foam composition of claim 7, exhibiting a compression set of 50% or less, 40% or less, 30% or less, or 20% or less.

9. The foam composition of claim 7, exhibiting a specific gravity of less than 1, less than 0.8, or less than 0.6.

10. A method of making a foam gasket comprising:
a) dispensing a flowable composition onto a surface of an article, the composition comprising 1) a chemical blowing agent; and 2) at least one crosslinkable silicone component, wherein the flowable composition is dispensed at a temperature sufficient to activate the chemical blowing agent; and
b) solidifying the flowable composition to form the foam gasket on the surface of the article;
wherein either:
i) the crosslinkable silicone component comprises an average of more than one free-radically reactive group; wherein the flowable composition further comprises 3) a free-radical initiator; and wherein the solidifying step comprises exposing the flowable composition on the surface of the article to at least one of UV radiation or heat to activate the free-radical initiator; or
ii) the dispensing the flowable composition comprises melting, mixing, blowing, and coating, at elevated temperature of the flowable composition, wherein the crosslinkable silicone component comprises a silicone thermoplastic polymer; and
wherein the solidifying the flowable composition on the surface of the article comprises physical crosslinking of silicone thermoplastic polymer to form the foam gasket on the surface of the article.

11. (canceled)

12. (canceled)

13. The method of claim 10, wherein the silicone thermoplastic polymer comprises a polyorganosiloxane block copolymer.

14. The method of claim 10, wherein the flowable composition further comprises a crosslinking agent comprising at least one multifunctional monomer, oligomer, or polymer that does not contain a silicone group.

15. A foam gasket comprising a foamed silicone thermoplastic polymer matrix; and fragments of a chemical blowing agent comprising remnants of shells of composite particles.

16. The foam gasket of claim 15, wherein the silicone thermoplastic polymer comprises a polyorganosiloxane block copolymer.

17. The foam gasket of claim 16, wherein the polyorganosiloxane block copolymer comprises silicone polyoxamide.

18. The foam gasket of claim 15, further comprising at least one filler selected from silica, glass bubbles, talc, flame retardants, pigments, and any combination thereof.

19. The foam gasket of claim 15, wherein an exterior surface of the foam gasket is non-tacky.

20. An article comprising:
a) a first surface;
b) a second surface configured to mate with the first surface, such that when the first surface and the second surface are mated, the article has a closed clamshell structure; and
c) a foam gasket disposed on the first surface, wherein the foam gasket comprises a foamed silicone thermoplastic polymer matrix and fragments of a chemical blowing agent comprising remnants of shells of composite particles.

21. The article of claim 20, comprising a battery pack.

22. The article of claim 20, wherein, after the first surface is mated with the second surface, separation of the second surface from the first surface leaves no residue of the foam gasket on the second surface.
